(19) United States
(12) Patent Application Publication
(10) Pub. No.: US 2026/0030885 A1
(43) Pub. Date: Jan. 29, 2026

(54) METHOD, APPARATUS, AND COMPUTER-READABLE MEDIUM FOR ROOM RECONSTRUCTION

(71) Applicant: Geomagical Labs, Inc., Palo Alto, CA (US)

(72) Inventors: Konstantinos Nektarios Lianos, San Francisco, CA (US); Prakhar Kulshreshtha, Sunnyvale, CA (US); Salma Jiddi, Los Angeles, CA (US); Ajaykumar Unagar, Mountain View, CA (US); Akash Garg, Westport, CT (US); Michael Campbell, San Francisco, CA (US); Philip Guindi, Mountain View, CA (US); Benn Herrera, San Rafael, CA (US); Philip Kuan, Cupertino, CA (US); Ashkon Nima, Seattle, WA (US); Bryan Tyler Parker, Astoria, NY (US); Brian Totty, Los Altos, CA (US)

(21) Appl. No.: 19/279,968

(22) Filed: Jul. 24, 2025

Related U.S. Application Data
(60) Provisional application No. 63/675,041, filed on Jul. 24, 2024.

(51) Int. Cl. G06V 20/00; G06T 17/00

(52) U.S. Cl. CPC G06V 20/36; G06T 17/00

(57) ABSTRACT

A method, apparatus, and computer-readable medium for room reconstruction including storing a parametric model of rooms, the parametric model being generated based on extraction of perceptual parameters from images corresponding to views of the rooms and estimation of an architectural layout of the rooms based at least in part on the one or more perceptual parameters, augmenting the parametric model by identifying architectural elements in the architectural layout and replacing the architectural elements in the parametric model with architectural models corresponding to the architectural elements, assigning materials to surfaces of the parametric model based at least in part on at least one of the perceptual parameters, determining a lighting setup based on at least one of the perceptual parameters, and rendering a three-dimensional model of the rooms based at least in part on the parametric model, the assigned materials, and the lighting setup.

### RELATED APPLICATION DATA

This application claims priority to U.S. Provisional Application No. 63/675,041, filed Jul. 24, 2024, the disclosure of which is hereby incorporated by reference in its entirety.

### BACKGROUND

Automated scanning of customer living spaces (e.g. rooms), to create interactive “digital twins” can be a way to solve the “imagination gap” faced by home furnishing retail consumers when making considered home furnishing purchases.

Home furnishings purchases need to harmonize and fit into a customer's personal space, and the cost (economic and time) for purchasing mistakes is high. This makes interactive digital twins to “simulate” purchases appealing. Digital twins can let retail customers explore and try product combinations, get product selection & design assistance, and build purchase confidence.

Over the past two decades, many attempts have been made to automate the construction of “interactive 3D digital twins” of indoor spaces, to facilitate and accelerate retail home furnishing commerce and interior design. The majority of these efforts have proven commercially unsuccessful for widespread consumer retail use, due to unreliability, inaccuracy, limited interactivity, poor runtime performance, excessive cost, user burden, or need for specialized hardware.

While generating an accurate, believable, interactive virtual model of an indoor space from everyday imagery (also known as indoor 3D reconstruction) is highly desirable, such indoor perception is a known hard problem for computer vision, even with specialized hardware and contemporary advancements in Artificial Intelligence (AI) technology.

Indoor environments tend to be particularly challenging for automated computer vision reconstruction for multiple reasons. First, indoor scenes tend to be dominated by blank walls and ceilings, uniform visual textures, have repeating visual patterns from factory-made objects, transparent or reflective surfaces, viewpoint variant lighting, and a general scarcity of distinctive visual features on the most salient surfaces. Second, indoor 3D reconstruction is made more challenging due to the lighting conditions of indoor environments which can have light levels which are orders of magnitude darker than outdoor environments—such low light conditions can inject digital camera sensor noise and motion blur into photography that further hinders the success of visual patch triangulation techniques and damaging any subtle texture present in the scene. Third, contemporary computer vision algorithms tend to have trouble simultaneously estimating surface geometry, surface materials/Bidirectional Reflectance Distribution Function (BRDFs), and 3D lighting because of the deep interplay, coupling, and ill-posed ambiguity between these factors. Fourth, widespread consumer use means that a wide range of everyday smartphone cameras will be used, with widely varying optics and sensor capabilities (of specifications often not known). Fifth, because this indoor photography is driven by non-skilled consumers with strong expectations of case-of-use and a limited attention span—the captured photography, vantage points, fields of view may prove limited and suboptimal for 3D reconstruction.

While the technical challenges are high, at the same time, consumer expectations of interactive interior design are also high. Unlike “view only” applications of digital twins (e.g. virtual real-estate walkthroughs), or “quick look” AR applications (e.g. superimposing virtual imagery over live AR video streams), interactive 3D interior design applications come with challenging consumer expectations that the digital twins will both accurately reflect the geometry and details of room with sufficient fidelity to access fit and stylistic harmonization, but also that customers can sensibly interact with elements in the room, including freely movable furniture already present in the room and changeable built-in elements. These ambitious user expectations are difficult to meet with state-of-the-art solutions.

There are currently no solutions in the market for customers to easily and automatically scan digital twins of whole rooms and that simultaneously provide (a) sufficient visual fidelity, (b) architectural details, (c) detection and dynamic/movable representations of existing furniture foreground objects in the room, and (d) viewpoint freedom. These factors are important for customers who wish to interactively furnish digital twins of their spaces.

Accordingly, there is a need for improvements in technologies for improved room reconstruction.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1A illustrates a high-level process flow diagram for room reconstruction according to an exemplary embodiment.

FIG. 1B illustrates a flowchart of a method for room reconstruction according to an exemplary embodiment.

FIG. 2 illustrates a flowchart for generating the parametric model of the one or more rooms according to an exemplary embodiment.

FIG. 3 illustrates a flowchart and examples for receiving a plurality of images corresponding to a plurality of views of the one or more rooms according to an exemplary embodiment.

FIG. 4 illustrates a flowchart and examples for extracting the one or more perceptual parameters from one or more images in the plurality of images according to an exemplary embodiment.

FIG. 5 illustrates a flowchart and examples for estimating an architectural layout of the one or more rooms based at least in part on the one or more perceptual parameters according to an exemplary embodiment.

FIG. 6 illustrates a flowchart and examples for identifying built-in architectural elements within the architectural layout based at least in part on the semantic information according to an exemplary embodiment.

FIG. 7 illustrates a flowchart and examples for identifying one or more movable objects in the one or more rooms based at least in part on the one or more perceptual parameters according to an exemplary embodiment.

FIG. 8 illustrates a flowchart and examples for refining the parametric model according to an exemplary embodiment.

FIG. 9 illustrates a flowchart and examples for augmenting the parametric model according to an exemplary embodiment.

FIG. 10 illustrates another flowchart and examples for augmenting the parametric model according to an exemplary embodiment.

FIG. 11 illustrates a flowchart and examples for replacing movable objects in the parametric model with proxy objects according to an exemplary embodiment.

FIG. 12 illustrates a flowchart and examples for assigning one or more materials to one or more surfaces of the parametric model based at least in part on at least one of the one or more perceptual parameters according to an exemplary embodiment.

FIG. 13 illustrates a flowchart for assigning one or more physically-based rendering materials to the one or more surfaces based at least in part on the one or more images and one or more material classes in the plurality of material classes for each surface in the one or more surfaces according to an exemplary embodiment.

FIG. 14A illustrates an example of the pixel identification process according to an exemplary embodiment.

FIG. 14B illustrates an example of identified core material properties of a sequence of patches/pixels according to an exemplary embodiment.

FIG. 14C illustrates an example of color alignment according to an exemplary embodiment.

FIG. 14D illustrates a process for scale estimation according to an exemplary embodiment.

FIG. 14E illustrates a color alignment of the present system compared to a simple color alignment scheme according to an exemplary embodiment.

FIG. 14F illustrates an example of color normalization to compensate for lighting according to an exemplary embodiment.

FIG. 14G illustrates the color normalization process according to an exemplary embodiment.

FIG. 14H illustrates an example of the results of the color normalization process according to an exemplary embodiment.

FIG. 14I illustrates an example of applying blended image texture for a multiple fixed viewpoint system according to an exemplary embodiment

FIG. 14J illustrates an example of applying blended image texture for a free viewpoint system according to an exemplary embodiment.

FIG. 15 illustrates multiple processes that can be used to determine a lighting setup according to an exemplary embodiment.

FIG. 16A illustrates a flowchart for modeling one or more room light sources based at least in part on the one or more images and the one or more perceptual parameters according to an exemplary embodiment.

FIG. 16B illustrates an example of a 3D semantic reconstruction according to an exemplary embodiment.

FIG. 17 illustrates a flowchart for calibrating studio lighting based at least in part on the one or more images and one or more perceptual parameters according to an exemplary embodiment.

FIG. 18 illustrates an example of calibrating studio lighting according to an exemplary embodiment.

FIG. 19 illustrates an example of ambient occlusion according to an exemplary embodiment.

FIG. 20 illustrates an example of generating an external environment according to an exemplary embodiment.

FIGS. 21A-21B illustrate a simplified example of image-based reconstruction according to an exemplary embodiment.

FIG. 22 illustrates an example of a multi-room space reconstructed according to the present method according to an exemplary embodiment.

FIG. 23 illustrates a reconstructed and virtually decorated room according to an exemplary embodiment.

FIG. 24 illustrates the components of a specialized computing environment configured to perform the processes described herein according to an exemplary embodiment.

### DETAILED DESCRIPTION

While methods, apparatuses, and computer-readable media are described herein by way of examples and embodiments, those skilled in the art recognize that methods, apparatuses, and computer-readable media for image-based room reconstruction are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

As discussed above, there currently are no systems that allow users/customers to efficiently and automatically scan a whole room with sufficient support for architectural details, foreground objects, visual fidelity, and viewpoint freedom, in order to interactively furnish their space.

Accordingly, there is a need for an improved solution for consumer whole room scan and design, that (a) offers high levels of automation (resulting in fast response times), (b) includes reconstruction of architectural details such as flooring, paint, mouldings, door and window styles, (c) enables detailed representations of foreground objects to be removed, repositioned, or left in place, and (d) maintains high visual fidelity—to be highly suggestive of the actual space.

The present solution provides a method, apparatus, and computer-readable medium for automated room reconstruction that provides several benefits, including:
reconstruction of architectural details and textures, such as flooring, paint, mouldings, door, window styles, paint, tile, wallpaper, etc.;
detailed representations of existing foreground objects (e.g., existing furniture objects) to be removed, replaced, repositioned, or left in place;
high visual fidelity—to be visually suggestive of the actual space; and
flexible viewpoint change within a space.

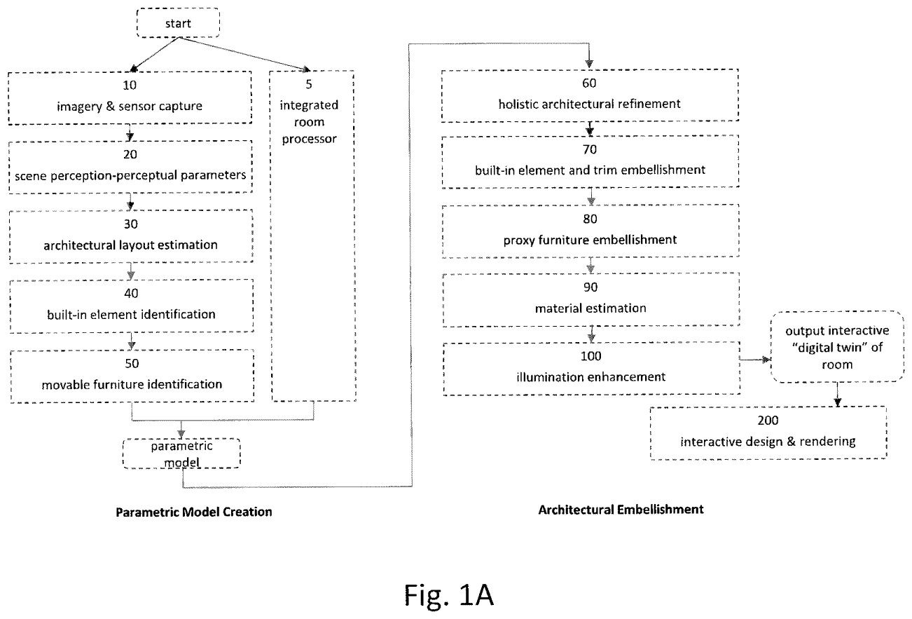

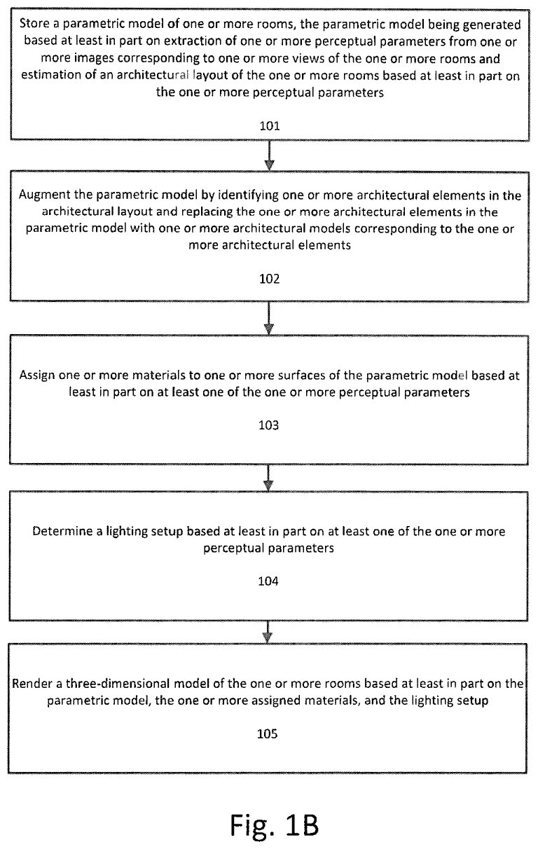

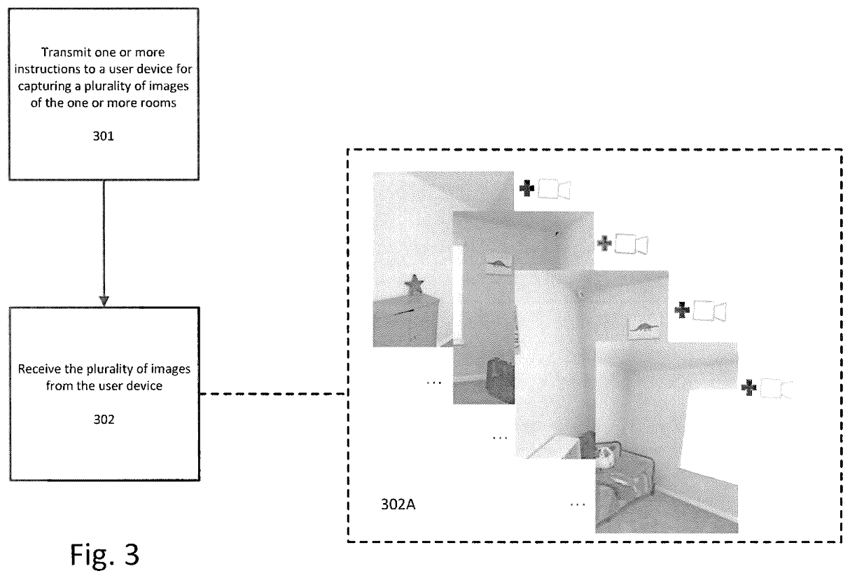

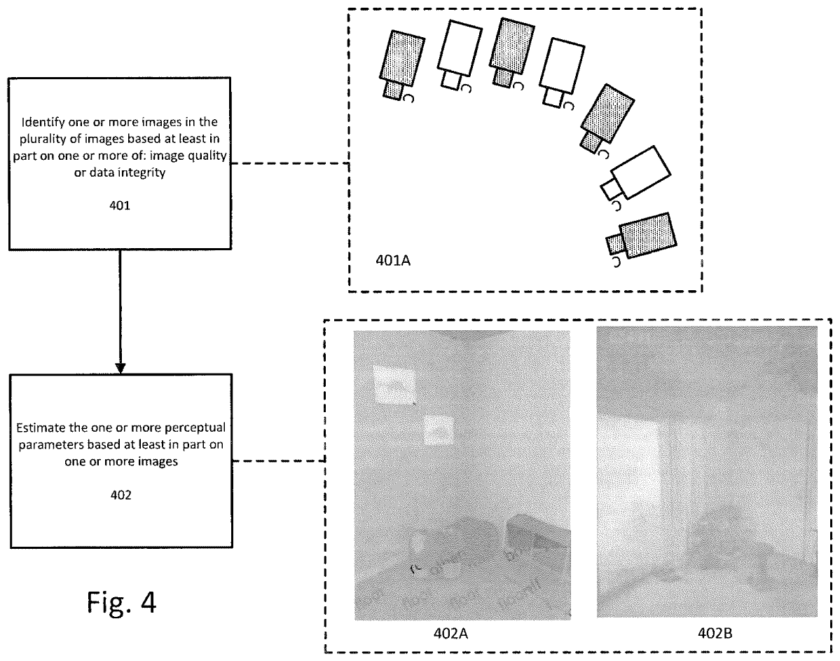

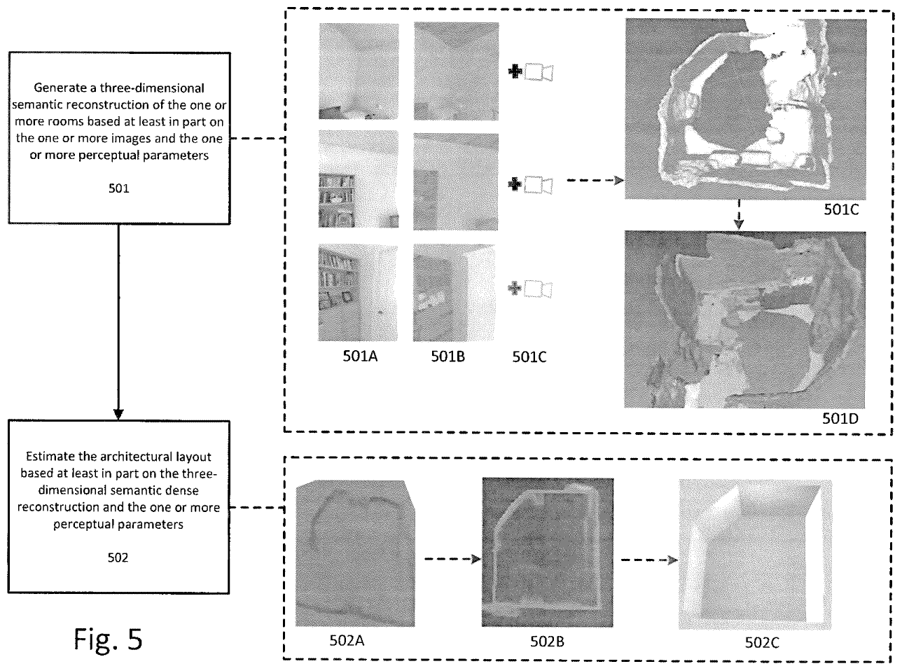

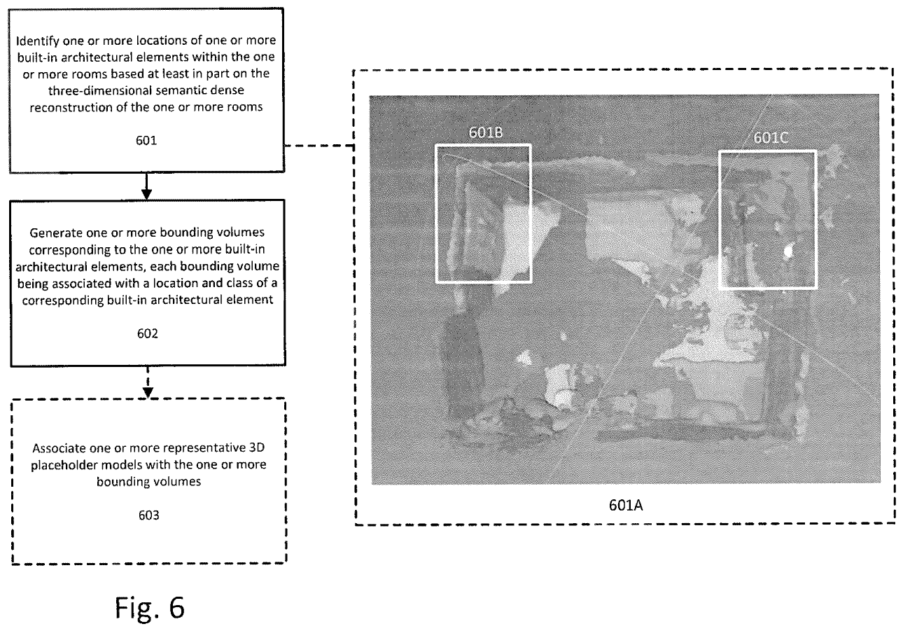

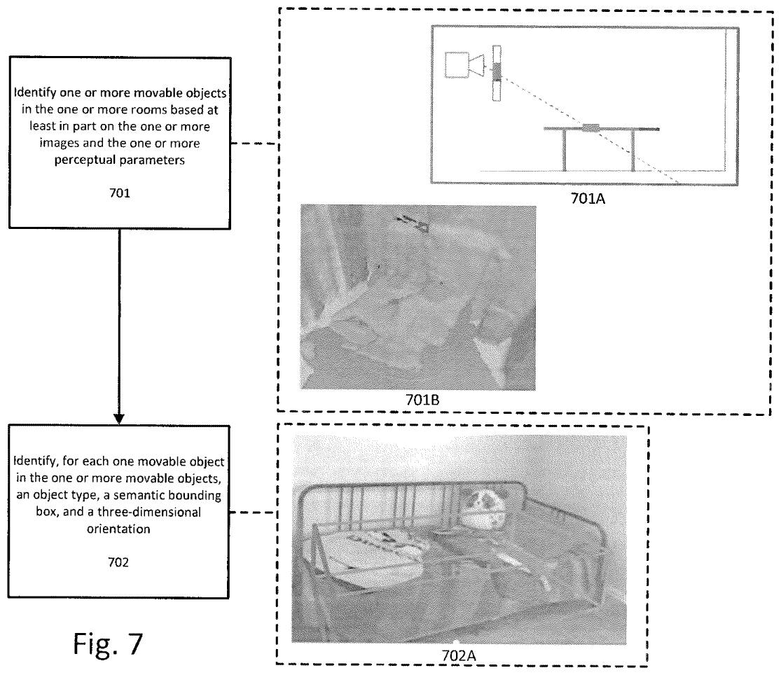

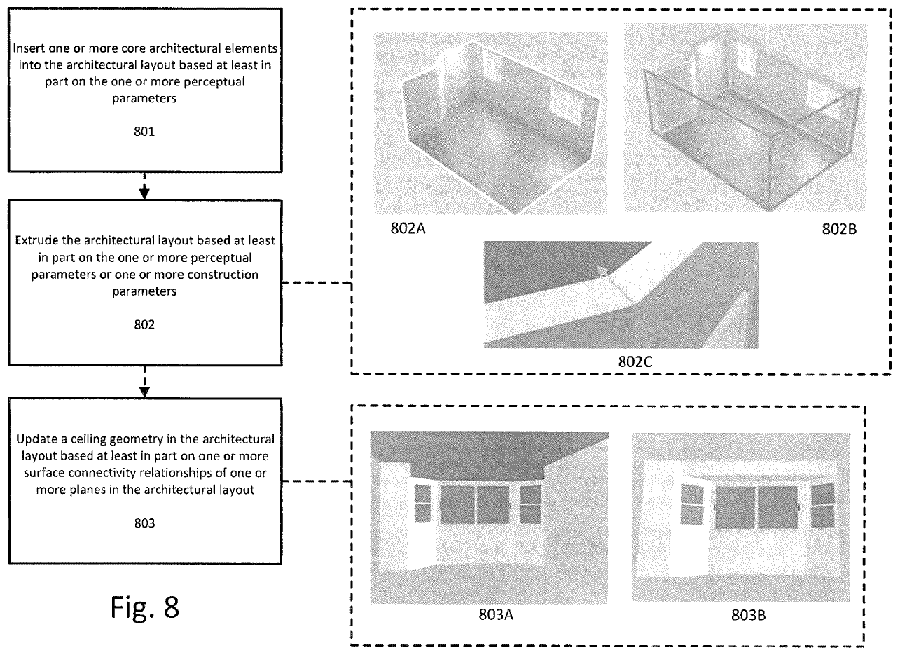

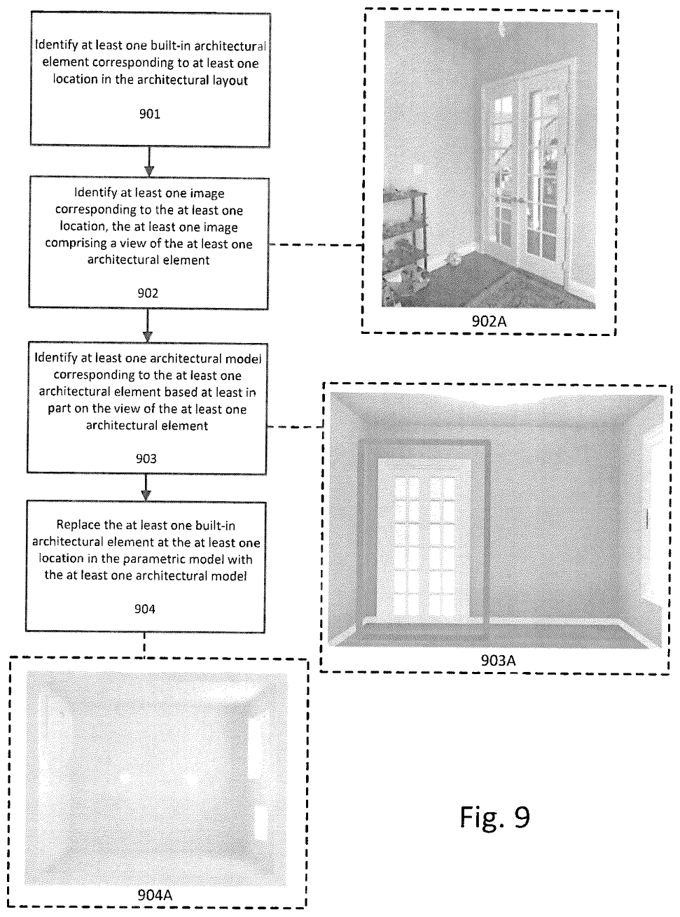

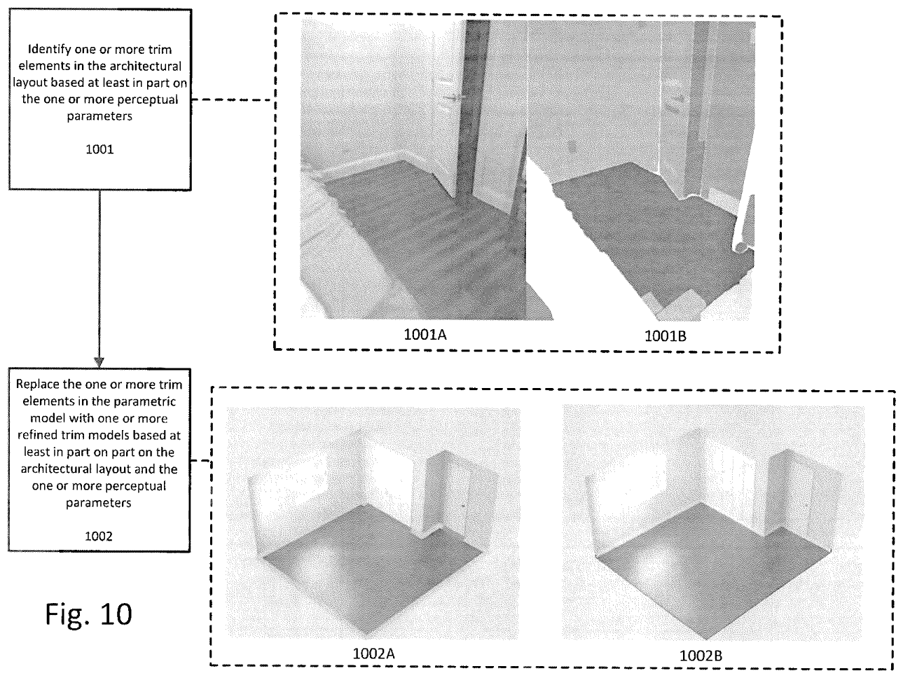

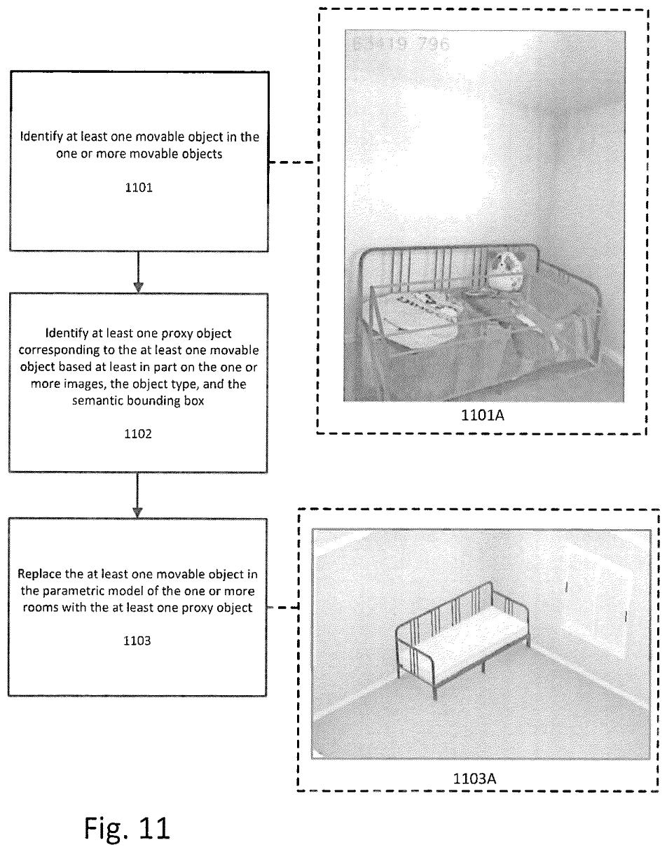

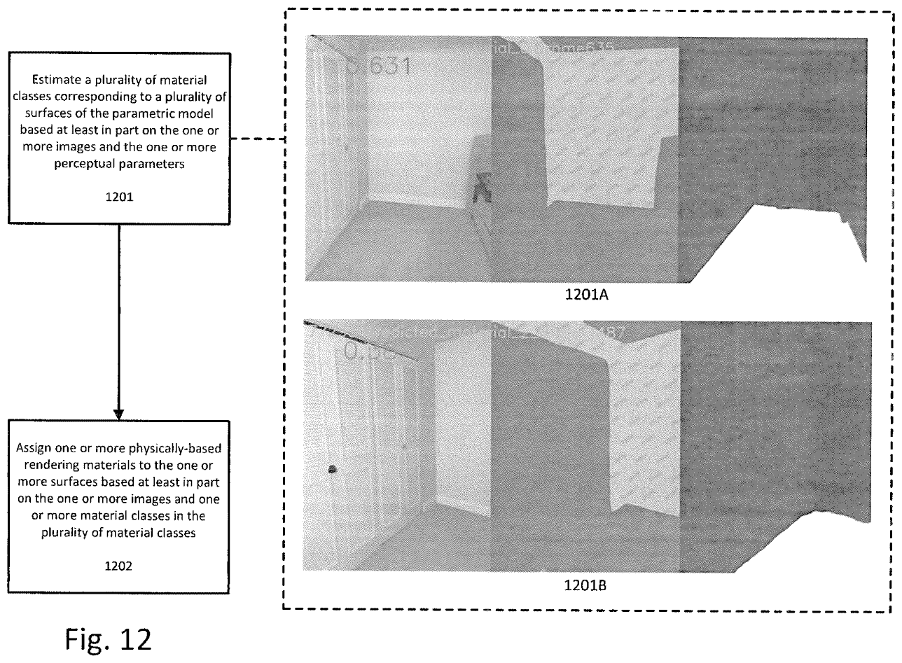

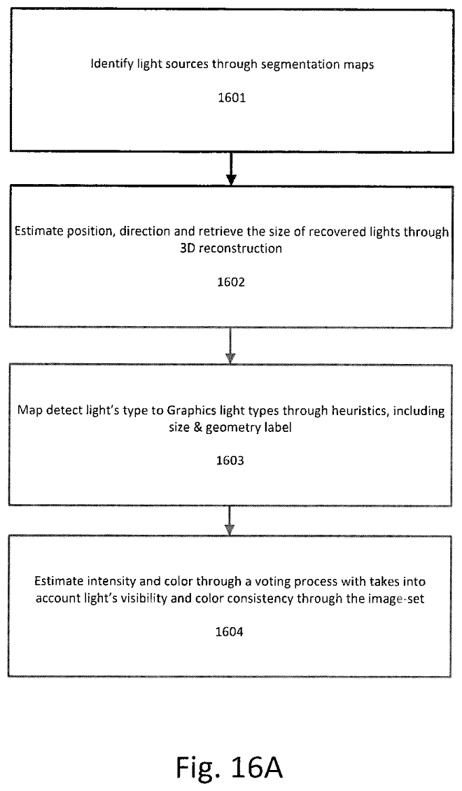

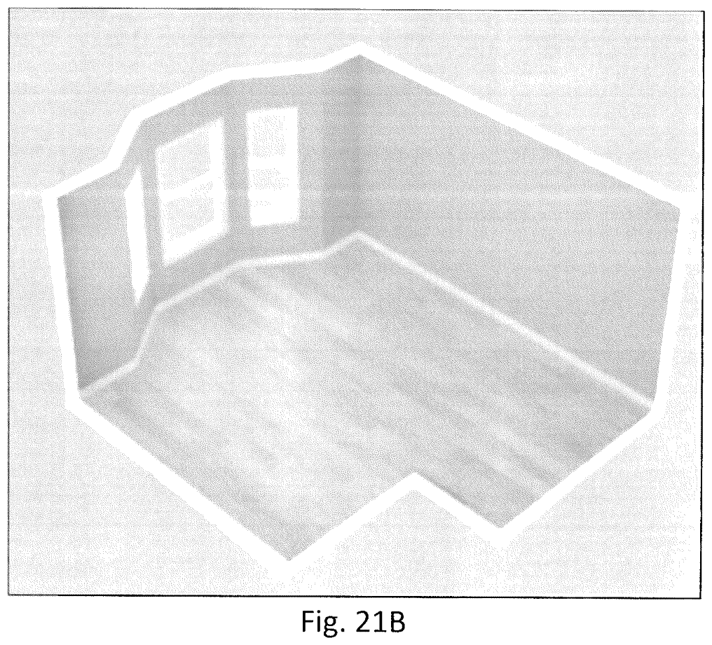

FIG. 1A illustrates a high-level process flow diagram for room reconstruction according to an exemplary embodiment. As shown in FIG. 1A, the process is divided into the stages of parametric model creation/input and architectural embellishment. Each of the steps in each stage is described in greater detail in the following figures and description sections. The steps of the high-level process flow diagram are indicated below, along with identification of the specific figures that provide additional details regarding each step:
10—imagery and sensor capture (FIG. 3)
20—scene perception-perceptual parameters (FIG. 4)
30—architectural layout estimation (FIG. 5)
40—built-in element identification (FIG. 6)
50—movable furniture identification (FIG. 7)
60—holistic architectural refinement (FIG. 8)
70—built-in element and trim embellishment (FIGS. 9 and 10)
80—proxy furniture embellishment (FIG. 11)
90—material estimation (FIGS. 12-14J)
100—illumination enhancement (FIGS. 15-20)
200—interactive design and rendering (FIGS. 21A-23)

Of course, not all steps in each stage are required to be executed. For example, an integrated room processor 5 may perform one or more of the steps in the parametric model creation stage. Additionally, one or more of the architectural embellishments may be omitted.

FIG. 1B illustrates a flowchart of a method for room reconstruction according to an exemplary embodiment. The steps in the method can be executed by one or more computing devices of the system. The ordering of steps shown in FIG. 1B is provided for illustration only and the steps may be performed in a different order than that shown in FIG. 1B.

At step 101 a parametric model of one or more rooms is stored, the parametric model being generated based at least in part on extraction of one or more perceptual parameters from one or more images corresponding to one or more views of the one or more rooms and estimation of an architectural layout of the one or more rooms based at least in part on the one or more perceptual parameters. A parametric model is a 3D model created and modified by defining parameters, constraints, formulas, variables, and relationships. Parameters are adjustable variables that define the model geometry. These can include dimensions, constraints, formulas, material properties, and more. By changing parameters, the model's geometry and behavior can be modified. Parametric modeling establishes relationships and constraints between different elements of a model. Constraints define the behavior of the geometry when changes are made. Parametric modeling ensures that the model maintains its intended behavior when modifications are made. By defining relationships and constraints based on design intent, parametric models can adapt to changes while preserving their overall design.

The one or more perceptual parameters can include a gravity vector corresponding to the one or more rooms, a depth map corresponding to the 3D depth of a plurality of pixels in a view of the plurality of views, an edge map corresponding to one or more edges in a view of the plurality of views, a normal map corresponding to one or more normals in a view of the plurality of views, a semantic map indicating semantic labels associated with a plurality of pixels in a view of the plurality of views, an instance map indicating a plurality of instance labels associated with the plurality of pixels in a view of the plurality of views, one or more object masks corresponding to one or more objects in a view of the plurality of views, one or more bounding boxes corresponding to one or more objects in a view of the plurality of views, a shadow mask corresponding one or more shadows in a view of the plurality of views, a three-dimensional camera pose corresponding to the approximate three-dimensional position and orientation of one or more views in the plurality of views, a three-dimensional volumetric fusion of two-dimensional view data, or a three-dimensional semantic map mapping one more voxels in the one or more rooms to one or more semantic labels.

Optionally, the system can receive a parametric model of the one or more rooms or one or more components of a parametric model that are then used to generate the interactive parametric model from an external system(s). The external system(s) can include one or more third-party systems and APIs that perform some of the steps or portions of steps used to generate the initial parametric model.

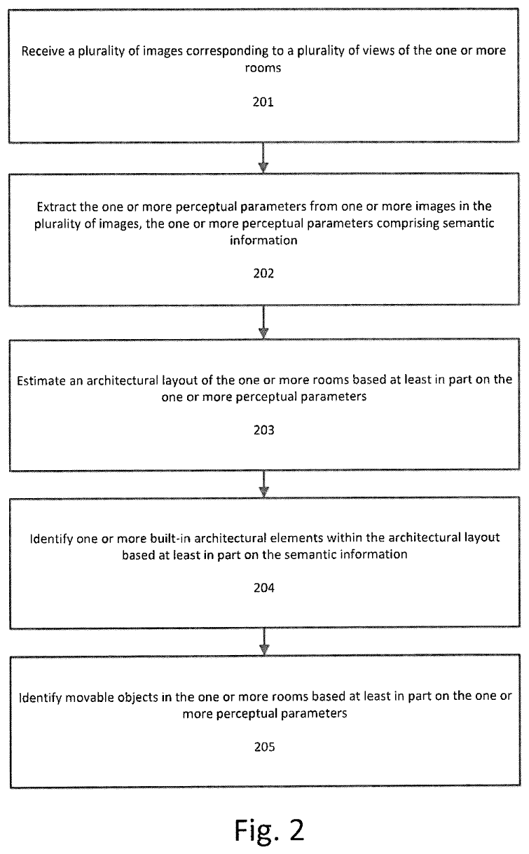

The system can generate the parametric model from images and perceptual parameters of the one or more rooms. FIG. 2 illustrates a flowchart for generating the parametric model of the one or more rooms according to an exemplary embodiment.

At step 201 a plurality of images corresponding to a plurality of views of the one or more rooms are received. The images can be received from a client device, such as a user mobile device or desktop computer. The images can be received via an API, such as through a mobile application on a device of a user. The step of receiving images can include receiving a plurality of frames of a video.

The one or more rooms can include living spaces, bedrooms, kitchens, or other residential rooms, as well as open spaces such as backyards, patios, auditoriums, music or event venues, etc.

Optionally, step 201 can include receiving additional data relating to the image capture, such as sensor data (accelerometers, motion sensors, position sensors, location sensors, LiDAR sensors, etc.) of a mobile device used to capture the images, timestamps, perceptual data, and/or other metadata associated with the image or image capture. Timestamps can be used in various scenarios, such as determining capture velocity and/or rotation, which is a good proxy for high quality frame selection, optical flow, etc. Perceptual data comprises any image-based signal such as HDR imagery, depthmaps or point clouds, detected semantics, layout etc. Sensor data includes non-image signals such as poses, IMU measurements, depth, lidar point clouds, camera intrinsics, global lighting, camera parameters like ISO, exposure, etc. Additional data can include augmented reality data such a camera intrinsics, camera poses, gravity (i.e., a gravity vector or equivalent), depth maps, features, or feature sets.

FIG. 3 illustrates a flowchart and examples for receiving a plurality of images corresponding to a plurality of views of the one or more rooms according to an exemplary embodiment.

At step 301 one or more instructions are transmitted to a user device for capturing a plurality of images of the one or more rooms. The instructions can be transmitted to a user interface of the user device and can instruct the user on how best to capture images of the one or more rooms. For example, the instructions can instruct users on where to stand, how many photos to take, whether to take a video, how to move or orient the mobile device, etc. The instructions can also include information how to upload or transmit the images and optional sensor data and/or metadata, as discussed above.

At step 302 the plurality of images are received from the user device. This step can include receiving sensor data, other perceptual data, timestamps, and/or any of the additional data described above. Box 302A illustrates an example of received images. The camera icon indicates sensor and/or perceptual data that can also be received.

Returning to FIG. 2, at step 202 the one or more perceptual parameters are extracted from one or more images in the plurality of images, the one or more perceptual parameters comprising semantic information. Semantic information is discussed in greater detail below and can include semantic tags/labels associated with pixels or voxels or any other type of semantic classification of the image content. This step is discussed in greater detail with respect to FIG. 4.

FIG. 4 illustrates a flowchart and examples for extracting the one or more perceptual parameters from one or more images in the plurality of images according to an exemplary embodiment.

At step 401 one or more images in the plurality of images are identified based at least in part on one or more of image quality and/or data integrity. This step can include selecting some or all camera frames based on coverage, image quality, data integrity, and system performance. Data integrity and system performance are related—both refer to the quality of input data as provided by the acquisition device (e.g. phones). The goal of this operation is to perform a check of the quality and consistency of data, and only select the inputs with high quality. For example, given a camera trajectory, as shown in box 401A, where Red-Green-Blue (RGB) and/or RGB+(Augmented Reality) AR data is collected, the system can select frames based on low blur score, spatial distance to other poses, coverage of entire trajectory, etc.

At step 402 the one or more perceptual parameters are estimated based at least in part on one or more images. Perceptual parameters can include object identification and semantic segmentation, as shown by 402A in the dashed box, or depth maps which store a depth associated with each pixel, as shown by 402B in the dashed box.

Perceptual parameters can also include a gravity vector corresponding to the one or more rooms, a depth map corresponding to the 3D depth of a plurality of pixels in a view of the plurality of views, an edge map corresponding to one or more edges in a view of the plurality of views, a normal map corresponding to one or more normals in a view of the plurality of views, a semantic map indicating semantic labels associated with a plurality of pixels in a view of the plurality of views, an instance map indicating a plurality of instance labels associated with the plurality of pixels in a view of the plurality of views, one or more object masks corresponding to one or more objects in a view of the plurality of views, one or more bounding boxes corresponding to one or more objects in a view of the plurality of views, a shadow mask corresponding one or more shadows in a view of the plurality of views, a three-dimensional camera pose corresponding to the approximate three-dimensional position and orientation of one or more views in the plurality of views, a three-dimensional volumetric fusion of two-dimensional view data, a three-dimensional semantic map mapping one more voxels in the one or more rooms to one or more semantic labels, multi-view fused reconstructions, or other perceptual information for use in later stages of reconstruction.

The step of estimating/determining one or more perceptual parameters can include determining the one or more perceptual parameters based at least in part on the one or more images and one or more data values captured by an image capture device. The one or more data values can correspond to one or more of a depthmap, a three-dimensional mesh, a camera pose, a gravity vector, LiDAR data, accelerometer data, gyroscope data, and/or tilt sensor data.

Returning to FIG. 2, at step 203 an architectural layout of the one or more rooms is estimated based at least in part on the one or more perceptual parameters. This step is described in greater detail with respect to FIG. 5.

FIG. 5 illustrates a flowchart and examples for estimating an architectural layout of the one or more rooms based at least in part on the one or more perceptual parameters according to an exemplary embodiment.

At step 501 a three-dimensional semantic reconstruction of the one or more rooms is generated based at least in part on the one or more images and the one or more perceptual parameters. This step can be performed by using images 501A, semantic maps 501B, and AR/sensor/orientation data 501C to generate a dense reconstruction 501D of the one or more rooms and then generate a dense semantic reconstruction 501E of the one or more rooms (using semantic maps 501B). The semantic reconstruction can take many different forms, such as voxels, polygon mesh, point cloud, signed distance field, etc. The semantic reconstruction is a three-dimensional representation of the one or more rooms that includes semantic labels attached to each coordinate/voxel/point/polygon in three-dimensional space.

At step 502 the architectural layout is estimated based at least in part on the three-dimensional semantic reconstruction and the one or more perceptual parameters. Estimating the architectural layout can include projecting the three-dimensional reconstruction to a floorplan view (i.e., a top-down or birds-eye view), as shown by 502A. Estimating the architectural layout can further include layout inference, in which deep learning and/or classical layout fitting techniques are used on the topdown view to determine a layout, such as shown by 502B. The layout fitting techniques can include techniques for layout inference of single or multiple rooms, partially or fully scanned. Estimating the architectural layout can further include refinement based on optimization and priors to produce a refined layout, as shown by 502C. These refinement processes can include processes described in U.S. patent application Ser. No. 18/213,115, filed Jun. 22, 2023, the disclosure of which is hereby incorporated by reference in its entirety.

The architectural layout can correspond to the surface geometry of the one or more rooms and associated architectural features, such as walls, ceilings, and floors. The present system is able to estimate and accurately model the architecture behind foreground objects while optionally omitting one or more of the foreground objects from the generated architectural layout or designating the foreground objects as movable/replaceable.

Returning to FIG. 2, at step 204 one or more built-in architectural elements within the architectural layout are identified based at least in part on the semantic information. The built-in architectural elements can include, for example, a window, a door, an appliance, a pass-through or cutout, a baseboard, and/or a moulding. This step is described in greater detail with respect to FIG. 6.

FIG. 6 illustrates a flowchart and examples for identifying built-in architectural elements within the architectural layout based at least in part on the semantic information according to an exemplary embodiment.

At step 601 one or more locations of one or more built-in architectural elements within the one or more rooms are identified based at least in part on the three-dimensional semantic reconstruction of the one or more rooms. The semantic reconstruction is described in greater detail above with respect to FIG. 5. This step estimates locations of built-in architectural elements, as well as object classes for those elements. Object classes can be, for example, baseboard, window, door, etc. The semantic tags that are embedded in the reconstruction identify built-in architectural elements and the three-dimensional reconstruction allows the system to identify a location in three-dimensional space for those elements. As shown in semantic reconstruction 601A, two locations 601B and 601C correspond to built-in architectural elements.

At step 602 one or more bounding volumes are generated corresponding to the one or more built-in architectural elements, each bounding volume being associated with a location and class of a corresponding built-in architectural element. This step can include generating a potentially-piecewise set of three-dimensional bounding volumes or bounding boxes, estimating the position and three-dimensional extent of the objects of interest, along with object class. Piecewise refers to the detection of the “built-in” elements in an indoor space, like windows and doors, or segments of moulding. For each of these, the system fits a 3D bounding volume or 3D polygon, with extents that cover its size, e.g. the size of a door. Large objects like complex wrap-around mouldings can be partitioned into pieces with smaller volumes. The set of 3D bounding volumes are the 3D volumes that represent built-in elements. And the 3D extent of an object refers to its dimensions.

At optional step 603 one or more representative 3D placeholder models are associated with the one or more bounding volumes. This step can include associating three-dimensional placeholder models that are representative of the object's class and size, or simplified three-dimensional shape placeholders (e.g. bounding box solids) approximating the object volume, shape or appearance.

The bounding volume is a precursor step-outlining the position, orientation and approximate volume of an object visible in the photographic scan. For example, a window or door can be delineated by a 3D rectangular box with width, height and depth, spanning the extent of the door, or a more complex 3D geometry. More complex-shaped elements like a sofa can also be delineated by a 3D rectangular box with width, height and depth, spanning the extent of the sofa, or a more complex 3D geometry.

A placeholder model is what is actually shown to the user in renderings, and what potentially allows user manipulation. A placeholder model servers as a proxy for the physical object visible in the images. There are multiple possible kinds of placeholder objects that can be used as proxies to represent physical objects in scene, at different levels of visual fidelity. In one approach, the system can represent the physical object with a simple volume or bounding shape-here a door or a sofa could be represented by a gray rectangular solid or other simple shape, with an optional text label, to “suggest” the presence of a physical object. Interior designers often use simple shapes like rectangles and circles to represent furniture (with a text label for furniture type). Another alternative for proxy placeholders is to display a generic 3D object (e.g. a generic 3D patio door, or a generic 3D chair) of similar size and/or dominant color, or a simplified, stylized placeholder chair (e.g. a grayed out simplified chair model).

With sufficient imagery and 3D estimation, the system can provide higher fidelity proxy representations as placeholders. The system can associate visible architectural features or furniture with 3D placeholder models from a 3D database that share salient architectural and/or visual features with the physical object, or identify exact instances of popular furniture from a 3D catalog, resulting in higher fidelity placeholders (i.e., proxy furniture, described below). Machine learning shape completion neural networks can also take partial 2D, 2.5D, or 3D views and hallucinate plausible 3D placeholders even without a catalog/database of 3D objects.

Returning to FIG. 2, at step 205 one or more movable objects in the one or more rooms are identified based at least in part on the one or more perceptual parameters. The movable objects can include furniture such as a sofa, table, chair, bed, desk, etc. Detection and placeholder synthesis for movable objects (e.g. furniture) has some aspects in common with detection and synthesis of built-in architectural elements, but there are some differences in the method due to the different use cases. This step is described in greater detail with respect FIG. 7.

FIG. 7 illustrates a flowchart and examples for identifying and locating one or more movable objects (e.g., furniture) in the one or more rooms based at least in part on the one or more perceptual parameters according to an exemplary embodiment.

At step 701 one or more movable objects in the one or more rooms are identified based at least in part on the one or more images and the one or more perceptual parameters. This step can include generating three-dimensional instance segmentation for movable objects, such as by using the three-dimensional semantic reconstruction and identifying three-dimensional instances using 3D segmentation neural networks to dense 3D instances of movable object candidates, such as shown by 701B. This step can also be performed by using 2D to 3D segmentation unprojection onto a 3D surface, such as shown by 701A.

At step 702 an object type, a semantic bounding box, and a three-dimensional pose (position and orientation) are identified for each movable object in the one or more movable objects. In the example shown in 702A, the system identifies a “bed” movable object type, along with a bounding box and three-dimensional orientation. This step can include 3D object detection techniques, such as those used the autonomous vehicle and VR industries, to estimate 3D orientations, size, and shape of each foreground object instance (e.g. bounding boxes). This step can additionally or alternatively use volumetric or point cloud 3D object detection techniques to convert one or more RGB or Red-Green-Blue-Depth (RGBD) views of each object instance to a 3D occupancy estimation of the object, with some details.

The movable objects can be integrated into the parametric model and placed within the parametric model so that the user can interact with the objects to move, delete, or replace them.

The parametric model of the one or more rooms can be further refined with architectural embellishments to more accurately represent the real-world space that is being modeled.

FIG. 8 illustrates a flowchart and examples for refining the parametric model according to an exemplary embodiment. The process of refining the parametric model can include one or more of the steps shown in FIG. 8. In other words, individual steps can be executed separate from other steps shown.

At step 801 one or more core architectural elements are inserted into the architectural layout based at least in part on the one or more perceptual parameters. This step uses the extracted room information to insert core architectural elements such as pass-throughs and soffits and holes. Specifically, this step utilizes semantic reconstruction and bounding volumes to carve out core architectural elements. Techniques for performing this step can include volumetric representations and entity embedded features.

At step 802 one or more wall planes in the architectural layout are extruded based at least in part on the one or more perceptual parameters or one or more construction parameters. This step extrudes wall planes based on geometric evidence and/or construction standards. To visually show “wall thickness,” planes are extruded from exterior edges of the scene to where outer wall boundaries intersect with floor or ceiling boundaries. Additionally, walls are extruded along the negative bisector of the room planes' edge angle, outside the room. The example illustrates a room model 802A, the planes in the room 802B, and the extrusion process 802C. Extrude means to extend flat geometry into 3D solids, i.e. add a thickness layer to the geometry (e.g. walls, floors, ceilings). Target thickness can vary based on geographic location, or visual evidence of the scene geometry with 4 in to 6 in being typical. This step increases realism (in the real-world, most geometric elements have a thickness) by procedurally augmenting the room layout with a standard thickness value.

At step 803 a ceiling geometry in the architectural layout is updated based at least in part on one or more surface connectivity relationships of one or more planes in the architectural layout. This step can include proposing ceilings connecting walls at a same height, in flat-ceiling models, and connecting walls of different heights, in non-flat-ceiling models. The proposals can then be verified and a wall-connectivity graph can be built by estimating ceilings that can cover the layout properly without cutting through any walls. In the example shown, the first model 803A has a defective ceiling with disconnected gaps and the second model 803B repairs the ceiling disconnections by inserting a soffit. Surface connectivity relationships are modeled as a graph of nodes, each node being a wall or ceiling, and each edge representing if these walls or ceilings are connected to themselves. The system then use the clusters formed to understand how to fit the ceilings best, so that they don't cut through existing walls.

Referring back to FIG. 1B, at step 102 the parametric model is augmented by identifying one or more architectural elements in the architectural layout and replacing the one or more architectural elements in the parametric model with one or more architectural models corresponding to the one or more architectural elements. This step identifies architectural elements that may not be accurately or completely represented in the parametric model and replaces them with higher fidelity models, as explained below.

FIG. 9 illustrates a flowchart and examples for augmenting the parametric model by identifying one or more architectural elements in the architectural layout and replacing the one or more architectural elements in the parametric model with one or more architectural models corresponding to the one or more architectural elements according to an exemplary embodiment. The process shown in FIG. 9 augments the parametric model by incorporating architectural models of architectural elements in the one or more rooms.

At step 901 at least one built-in architectural element corresponding to at least one location in the architectural layout is identified. This built-in architectural element can be identified using the process shown in FIG. 6.

At step 902 at least one image corresponding to the at least one location is identified, the at least one image comprising a view of the at least one architectural element. Given a positioned target built-in element, the system select a photographic detail image or images that best capture the detail of the targeted built-in object by maximizing frame scoring heuristics. This can include one or more of a visibility score indicating the amount of the surface visible in the frame, an orthogonality score indicating a dot product of camera viewing angle and polygon normal, and/or a distance score corresponding to camera proximity from the surface. Example 902A shows a selected frame where the architectural element is clearly visible.

At step 903 at least one architectural model corresponding to the at least one architectural element is identified based at least in part on the view of the at least one architectural element. This step can include search database for parametric built-in 3D architectural objects that best match the targeted built-in object/element, using vector-embedded search or other appropriate match methods. The search can generate embeddings of each architectural element class using CLIP, or similar techniques, for an optionally predefined set of class/asset pairs such as door: glass, panel, french, bifold, etc. The search process can then retrieve CLIP embeddings from selected frame(s) and match “frame(s)” to the “class” embeddings and choose a class with the closest match. CLIP is an algorithm that takes an image as an input and calculates a vector of numbers as output. A distinctive property of this output vector is that it has a similar value for images of similarly-looking objects, despite the images having different viewpoints, lighting conditions, clutter and others. Hence, CLIP can be used to match the object that in an image to a screenshot of a 3D object in a database. Example 903A illustrates a retrieved architectural model of type “French Door,” with a similar window pattern visible in the targeted imagery.

If there is no close match in the database, the system can use 3D shape completion methods to use 2D images and 3D geometry to propose architectural model candidates. Alternatively, the system can use default placeholder objects of generally the right type, size, and color to suggestively represent the architectural element.

At step 904 the at least one built-in architectural element at the at least one location in the parametric model is replaced with the at least one architectural model. This step can include sizing and positioning the built-in object by selecting best aspect ratio, sizing to match inferred room geometry, and placing in 3D position, orientation, etc. For example, this step can use the element's polygon size to find height/width ratio, use aspect ratio-based heuristics, infer the appropriate size of the 3D architectural model (e.g. single door, double door), scale the model it to fit within the estimated room geometry, and position the architectural model at the bounding box position determined previously. Example 904A illustrates a reconstruction with door and window built-in elements inserted. The inserted architectural model/reconstruction is built on top of the base parametric model, which includes the room boundaries/walls and/or the 3D bounding boxes of the built-in elements and movable furniture objects.

FIG. 10 illustrates another flowchart and examples for augmenting the parametric model by identifying one or more architectural elements in the architectural layout and replacing the one or more architectural elements in the parametric model with one or more architectural models corresponding to the one or more architectural elements according to an exemplary embodiment. The process shown in FIG. 10 augments the parametric model by replacing architectural trim elements in the one or more rooms with higher-fidelity versions.

At step 1001 one or more trim elements in the architectural layout are identified based at least in part on the one or more perceptual parameters. Trim elements include baseboards, crown mouldings, and other common architectural trim elements. This step can use neural network and geometric techniques to identify trim elements. For example, a Semantic Segmentation Network can be used to predict ‘baseboard’ and ‘moulding’ class. The network can be used on one or many frames/images, after which the segmentation labels can be collected and projected into 3D using available geometry/reconstruction. Since networks can be limited by poor training data and visual ambiguity for mouldings, an unsupervised segmentation network can also be used, along with detected wall-floor seams (using available room layouts). Then, the closest segment to this seam can be designated as a baseboard. Similarly, wall-ceiling seams can be used to identify ‘moulding’ elements. Another technique is to query a Multimodal Large Language Model (LLM) LLM, to comment on the presence and the attributes of a baseboard in the scene. Attributes can include size, shape, color, spatial location, and type. The example illustrates an image 1001A and the processed image 1001B with trim elements identified.

At step 1002 the one or more trim elements in the parametric model are replaced with one or more refined trim models based at least in part on part on the architectural layout and the one or more perceptual parameters. This step can refine and extrapolate the placement, dimensions, profile, and color of mouldings or other trim elements based on room geometry and semantics. For example, baseboard path segments can be calculated where wall edge boundaries meet the floor edge boundary, shown in orange in example 1002A. This yields path segments that exclude doorways and “interior 2-dimensional wall segments,” shown in blue in example 1002A. Moulding insertion can be achieved via the same algorithmic steps. This step then parameterizes height, depth, and color of the baseboard/mouldings and uses a geometric profile to procedurally generate the baseboard/mouldings/trim geometry objects. Example 1002B illustrates baseboard dimensions, profile, and color.

The replacement of objects with higher fidelity or substitute versions can be extended to movable objects within the room. FIG. 11 illustrates a flowchart and examples for replacing movable objects in the parametric model with proxy objects according to an exemplary embodiment. The process shown in FIG. 11 augments the parametric model by replacing existing objects with proxy objects.

At step 1101 at least one movable object in one or more movable objects is identified, the at least one movable object having one or more corresponding images, a corresponding object type, and a corresponding semantic bounding box. This step can be performed using the process described with respect to FIG. 7. The identified movable object can have a corresponding pose and type. Example 1101 illustrates a bed movable object.

At step 1102 at least one proxy object placeholder corresponding to the at least one movable object is synthesized based at least in part on the one or more images, the object type, and the semantic bounding box.

Step 1102 can generate multiple forms of movable objects at multiple layers of fidelity, as described previously, including similar methods for built-in architectural features described herein.

Step 1102 can include using 2D and 3D segmentation, bounding boxes, and RGB images to search for a close match in a database of 3D model objects (e.g. using vector embedded search). For each target object, the system can generate an orientation-agnostic embedding containing geometric and semantic cues. Then for each known 3D model in the database, the system can precompute and store embeddings in the same embedding space. The system can then perform a distance-based vector search to rapidly select similar candidates from database. The system can then 3D align the closest models to improve orientation and scale. Rendered differences can be used for model/orientation confidence.

If there is no close match in the database, the system can use 3D shape completion methods to use 2D images and 3D geometry to propose 3D model candidates. Alternatively, the system can use default placeholder objects of generally the right type, size, and color to suggestively represent the product.

At step 1103 the at least one movable object in the parametric model of the one or more rooms is replaced with the at least one proxy object. This step includes placing the 3D proxy furniture object in the scene, at the right position, orientation, and scale to serve as a movable placeholder for the real object visible in the imagery. Example 1103A illustrates an example proxy object inserted in place of the bed shown in example 1101A.

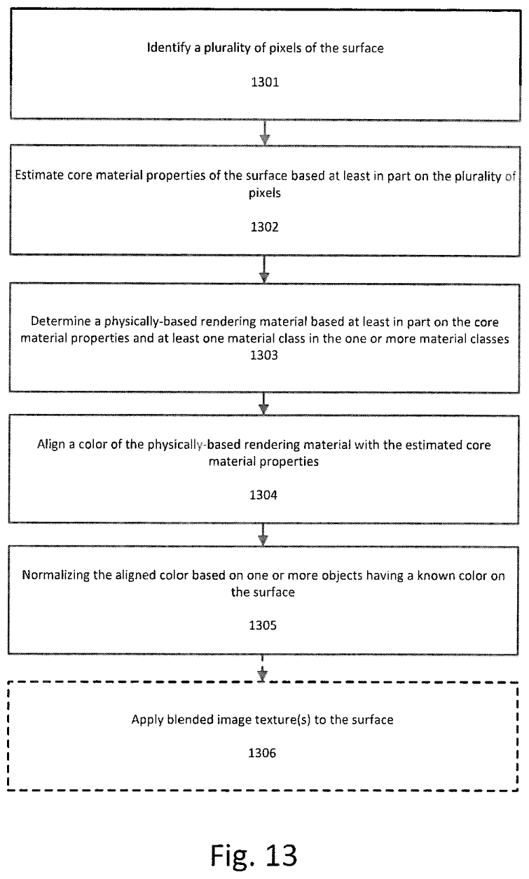

Returning to FIG. 1B, at step 103 one or more materials are assigned to one or more surfaces of the parametric model based at least in part on at least one of the one or more perceptual parameters. This step is especially important to create suggestive representations of flooring, paint, tile, wall coverings, paneling, countertops, or other important surface details that have important aesthetic implications for the room model. This materials synthesis step is described in greater detail with respect to FIGS. 12-13.

FIG. 12 illustrates a flowchart and examples for assigning one or more materials to one or more surfaces of the parametric model based at least in part on at least one of the one or more perceptual parameters according to an exemplary embodiment.

At step 1201 the system estimates material classes (e.g. paint, wood, carpet, tile, marble, glass, etc.) corresponding to a plurality of surfaces of the parametric model based at least in part on the one or more images and the one or more perceptual parameters. This step can first utilize camera poses, image details, and perceptual data like geometry and semantics (e.g. wall, floor, ceiling, etc.) to filter or score which images or patches of images contain the best surface visibility and detail.

At step 1202 one or more physically-based rendering materials (PBRM) are assigned to the one or more surfaces based at least in part on the one or more images and one or more material classes in the plurality of material classes. This step can take as input the images/frames, perceptual cues, camera parameters, 3D surfaces/mesh, and/or material classes. This process is described in greater detail with respect to FIG. 13.

FIG. 13 illustrates a flowchart for assigning one or more physically-based rendering materials to the one or more surfaces based at least in part on the one or more images and one or more material classes in the plurality of material classes for each surface in the one or more surfaces according to an exemplary embodiment.

At step 1301 a plurality of pixels of the surface are identified. This step samples image pixels/patches from one or more of: (a) RGB frames, (b) their 3D surface projection, or (c) from a novel view plenoptic (light field) render. For objects, the system performs a mesh projection and scores each pixel by perceptual cues for effectiveness as a target pixel.

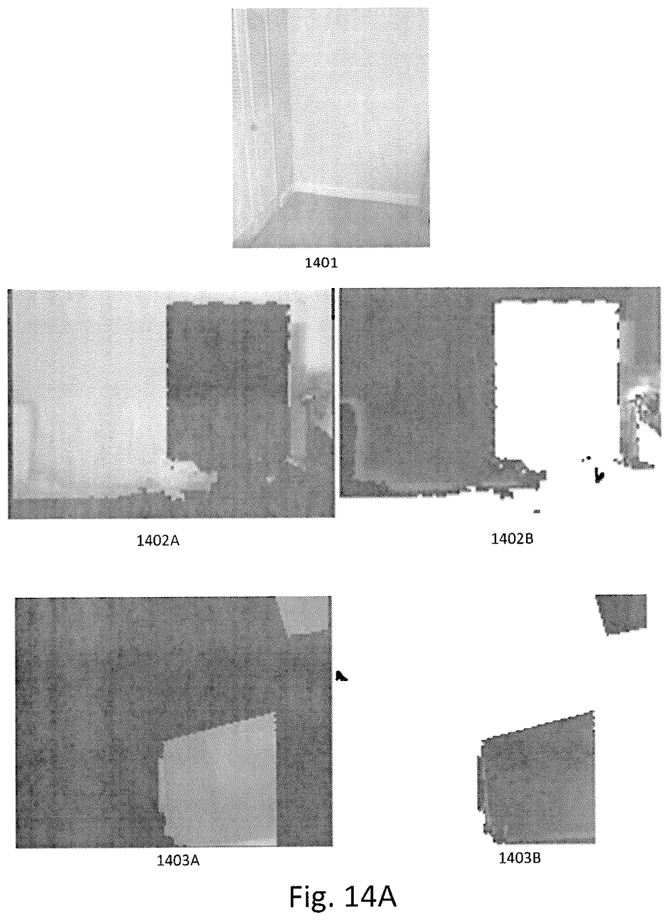

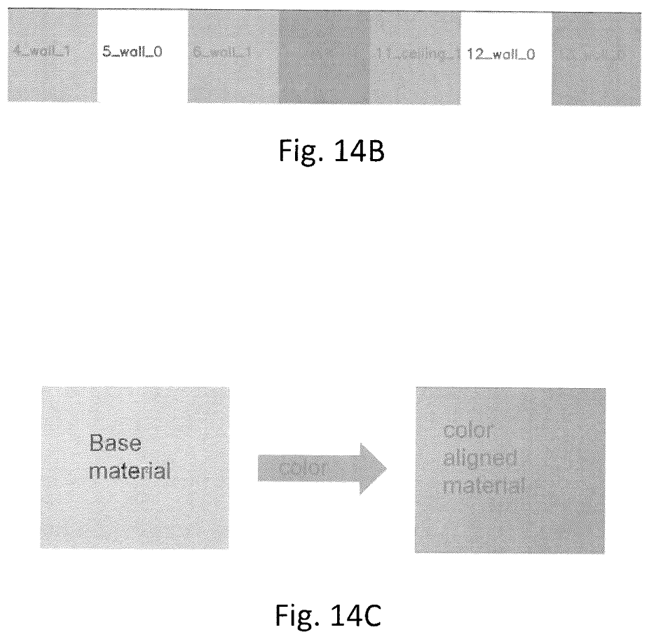

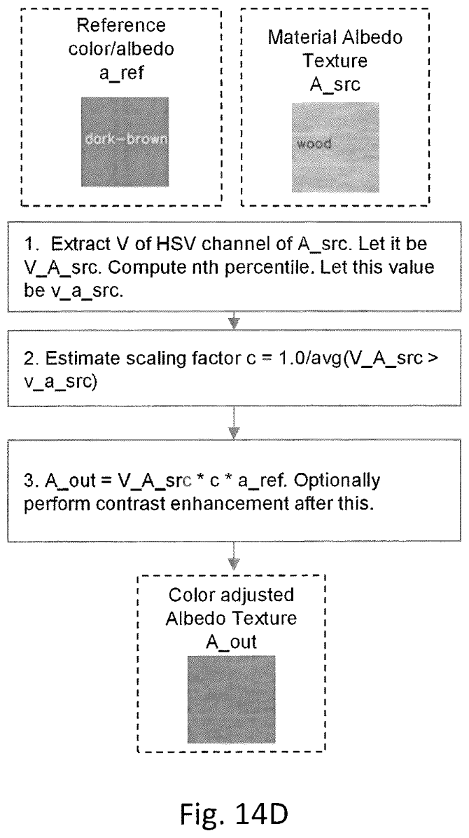

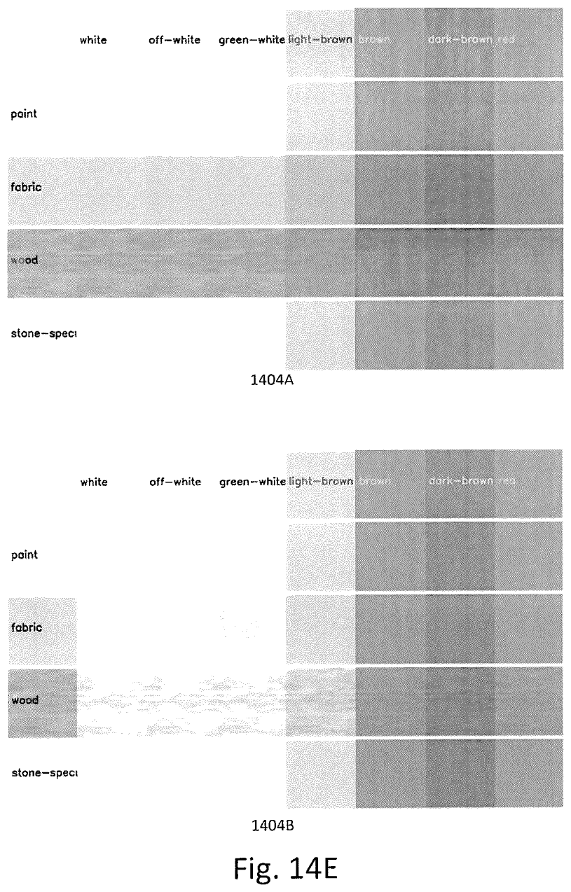

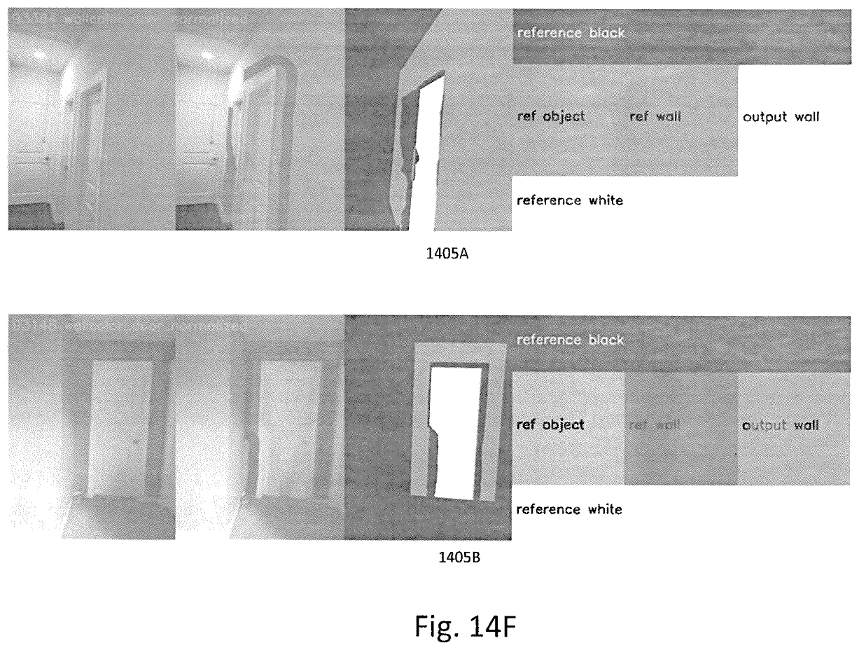

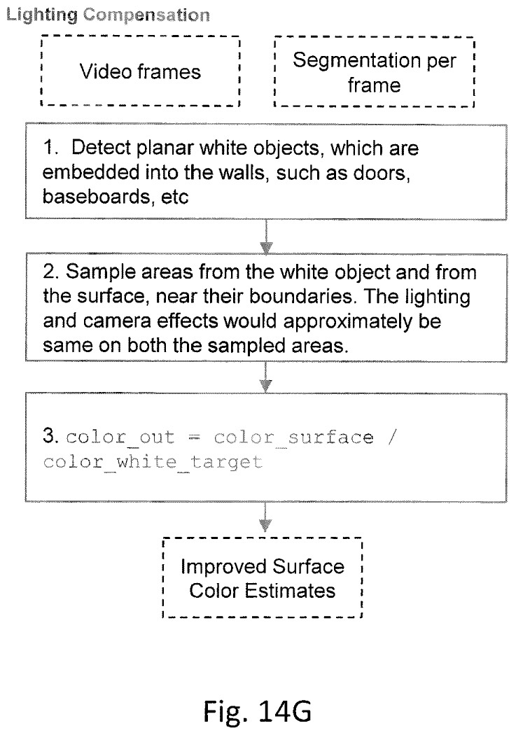

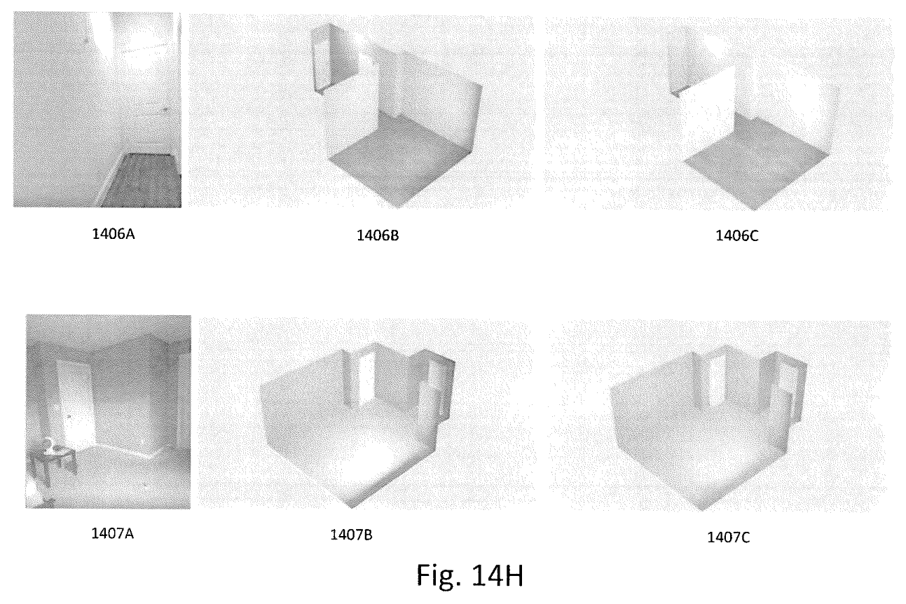

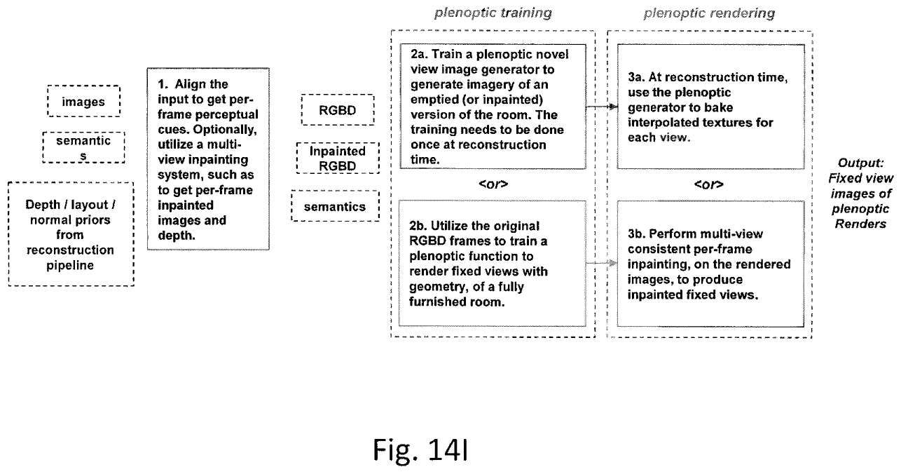

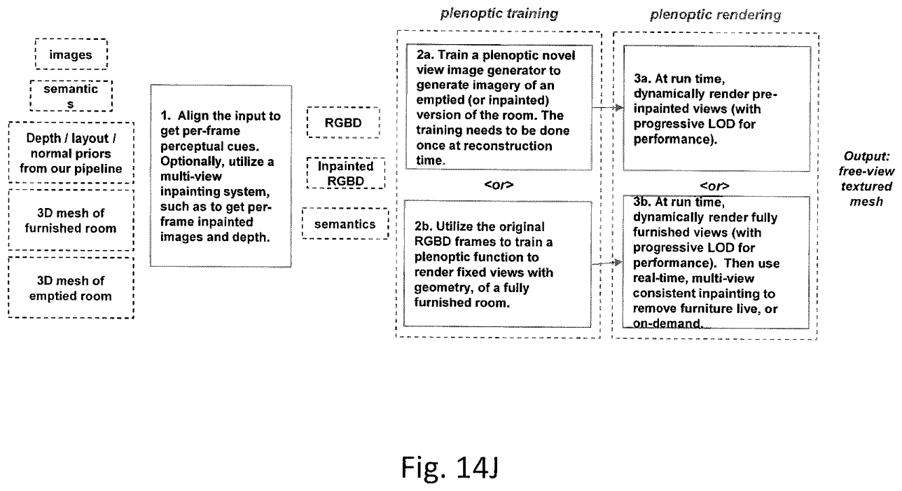

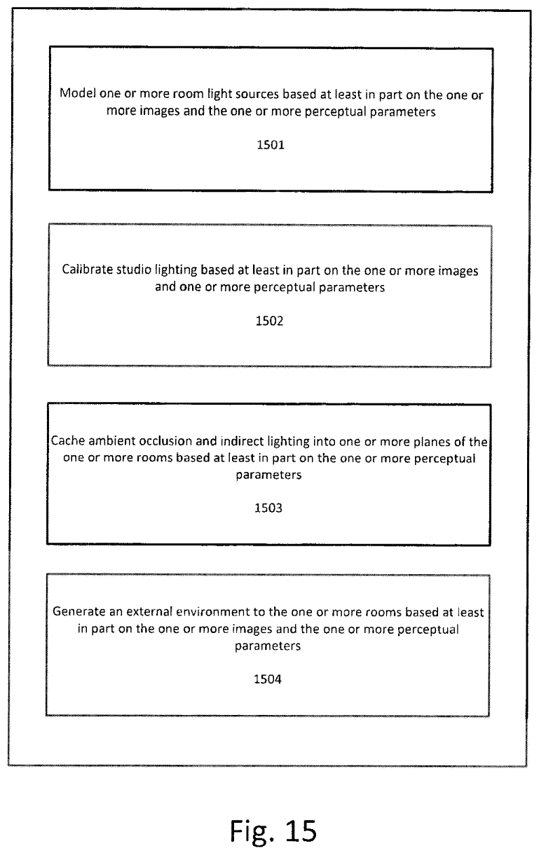

FIG. 14A illustrates an example of the pixel identification process according to an exemplary embodiment. The view shown in image 1401 is separated into an orthographic projections of wall 1402A and 1402B and floor 1403A and 1403B.

Returning to FIG. 13, at step 1302 core material properties of the surface are estimated based at least in part on the plurality of pixels. This can include estimating robust, global material properties for surfaces (color, albedo, roughness, metallicity, normal-map, material category, etc.). These can be obtained by aggregating predictions from a material properties estimation network, over multiple frames, and then performing a majority voting.

FIG. 14B illustrates an example of identified core material properties of a sequence of patches/pixels according to an exemplary embodiment.

Returning to FIG. 13, at step 1303 a physically-based rendering material is determined based at least in part on the material class and plurality of selected pixels. The purpose of this step is to identify a texture instance that is visually suggestive of the imagery and semantics of the scene. Multiple methods can be employed to provide a sufficient texture instance match. One method is searching a discrete texture bank of materials for closest match to the image patches which is also consistent with the material class, where the search matching score can take into account photometric pixel similarity, structural elements like lines, or high-level feature embeddings that represent the visual patterns as latent features. A second method to find material instance is to use vector embedded search of a discrete texture bank, where both pixel patches and texture bank is encoded into a salient vector space of features. A third method to find material instance is create a bespoke material from imagery using pixels, Generative AI extrapolation, or inverse rendering.

At step 1304 a color of the physically-based rendering material is aligned with the estimated core material properties. This step aligns the color and (optionally) other properties of the fetched material with estimated core material properties. This step also aligns the scale and the orientation of the material. The goal is to adjust the intrinsic colors of a material (e.g. from a limited bank of wood patterns) so they better align with a desired targeted color, while still preserving their unique texture and pattern. This step also aligns the scale and the orientation of the material.

Common approaches often convert the material to grayscale and then multiply it by the reference color. However, this often leads to poor results. The output can become too dark, or lose its brightness range. To produce more consistent and photorealistic results, our method adjusts the material's brightness before applying the reference color. This is done by analyzing the brightness distribution of the original texture, and normalizing it. The reference color is then multiplied by this normalized material. By doing this, the final result maintains the original material's detail—like fabric weave or wood grain—but shifts its overall color tone to match the desired reference, with more visually consistent brightness across different material types.

FIG. 14C illustrates an example of color alignment according to an exemplary embodiment. FIG. 14D illustrates a process for scale estimation according to an exemplary embodiment. Given a material, and a ‘reference color’, the goal is to update the material so that its base/intrinsic color matches the reference color. For instance, the system may encounter in a material bank a brown fabric material—the goal is to then cast its base color to a ‘reference color’ e.g. grey. Color alignment can be tricky. If the system naively converted a material to grayscale and then multiplied it with color_ref, this would result in some materials getting dark, light wood and fabric below. Accordingly, the present system performs the conversion by multiplying color_ref to scaled Value channel of Hue, Saturation, Value (HSV) colorspace. Scale is estimated as described in the process shown in FIG. 14D. FIG. 14E illustrates a color alignment of the present system 1404B compared to a simple color alignment scheme 1404A according to an exemplary embodiment.

Returning to FIG. 13, at step 1305 the aligned color is normalized based on one or more objects having a known color on the surface. The known color can be white. In this case, this step detects likely white planar objects (W) in the scene (door, baseboard, ceiling, etc) and normalizes the color estimate with the color estimate of W on the same surface.

FIG. 14F illustrates an example of color normalization to compensate for lighting according to an exemplary embodiment. The estimated surface color in a scene could be wrong because it would contain effects such as lighting, shadow, etc. For instance, in the top figure shown in FIG. 14F, the walls are white, but the color-estimates suggest a grey shade. To compensate for this, the present system identifies, within the same surface, existing white objects. These can potentially share the same lighting and camera artifacts. This allows the system to improve the surface color estimation.

FIG. 14G illustrates the color normalization process according to an exemplary embodiment. FIG. 14H illustrates an example of the results of the color normalization process according to an exemplary embodiment. 1406A illustrates a room with white walls. Before normalization, the walls look beige 1406B. After normalization, the walls look white 1406C. Similarly, 1407A illustrates a room with yellowish walls. Before normalization, the walls look greenish 1407B. After normalization, the walls look yellowish 1407C.

Returning to FIG. 13, optionally, at step 1306 blended image texture(s) are applied to the surface. This step can reproduce high fidelity texture detail. For regions that appear to have high-fidelity surface detail, not caused by foreground objects or viewpoint specific shading, this step applies blended image textures from projected RGB imagery and/or novel view/plenoptic renders.

FIG. 14I illustrates an example of applying blended image texture for a multiple fixed viewpoint system according to an exemplary embodiment. For realistic view rendering, one approach is to restrict views to a set of fixed viewpoints. They do not all need to be viewpoints a user scanned—the system can use a plenoptic novel-view engine (using image+depth+normal priors) to estimate the image from any view. Because this approach only supports a fixed, finite set of views, the system can bake each view once at reconstruction time. A key challenge is foreground objects which are removed through inpainting-either before or after the novel view generation.

FIG. 14J illustrates an example of applying blended image texture for a free viewpoint system according to an exemplary embodiment. For free viewpoints (or at least substantial viewpoint change), viewpoint-varying lighting makes it unsatisfying to use static baked textures. In this case, the system uses a real-time novel view (plenoptic) render engine (on the client or streaming from the server with appropriate caching/LODs/interpolation for performance) combined with foreground object removal.

Returning to FIG. 1B, at step 104 a lighting setup is determined based at least in part on at least one of the one or more perceptual parameters.

FIG. 15 illustrates multiple processes that can be used to determine a lighting setup according to an exemplary embodiment. The system can utilize one or more of steps 1501-1504 when determining a lighting setup.

At step 1501 one or more room light sources are modeled based at least in part on the one or more images and the one or more perceptual parameters. This step uses the imagery and perception information to detect and model the light sources that match the lighting conditions in the scanned room(s). This includes type, color, intensity, position, orientation, volume, etc.

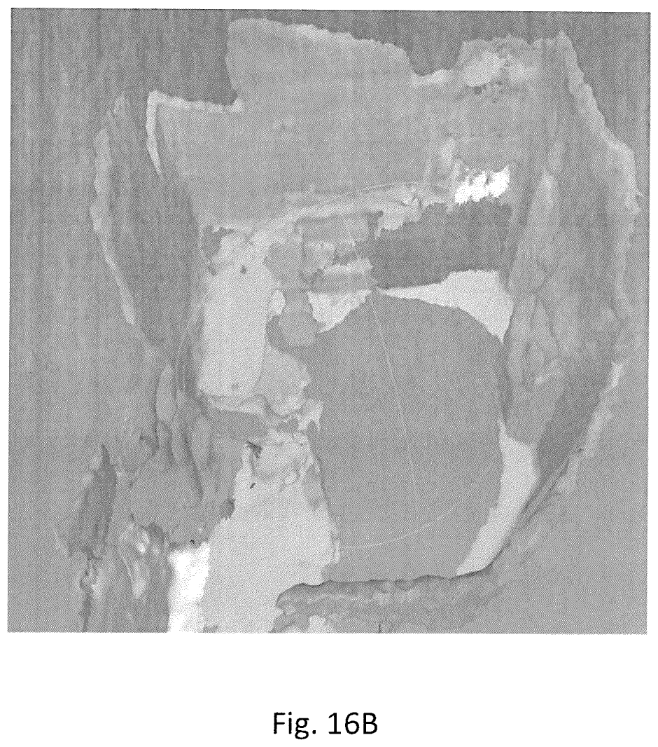

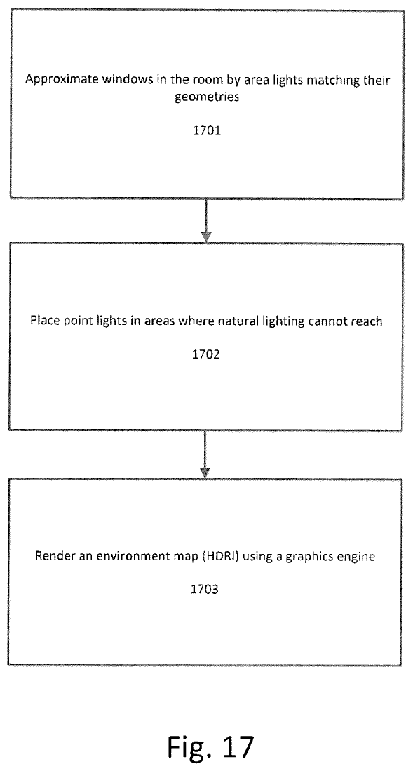

FIG. 16A illustrates a flowchart for modeling one or more room light sources based at least in part on the one or more images and the one or more perceptual parameters according to an exemplary embodiment. The process can take as input the images, perceptual information including semantic information, poses, camera intrinsics, the three-dimensional semantic reconstruction and produce as output a set of light sources along with their attributes, such a type, position, orientation, size, and/or intensity.

At step 1601 the system identifies light sources through segmentation maps.

At step 1602 the system estimates position and direction and retrieves the size of recovered lights through 3D reconstruction.

FIG. 16B illustrates an example of a 3D semantic reconstruction according to an exemplary embodiment.

Returning to FIG. 16A, at step 1603 the system maps detect light types to Graphics light types through heuristics, including size, and geometry labels.

At step 1604 the system estimates intensity and color through a voting process which takes into account light visibility and color consistency through the image-set.

Returning to FIG. 15, at step 1502 studio lighting is calibrated based at least in part on the one or more images and one or more perceptual parameters. This step uses the extracted information to calibrate a Studio-like lighting set-up; offering a pleasant & ideal room rendering.

In this step, given the textured shell of an indoor environment, the system generates a lighting setup, i.e. a list of light sources of various types, that ensures optimal lighting of the scene when rendered with graphics engines. Each light can optionally be associated with a 3D model, such as lamp, ceiling light, wall-fitted bulb, etc. The setup consists of various lighting types, including: point, spot, directional and area lights; global environment map; one or more local environment maps; and/or light field, radiance map.

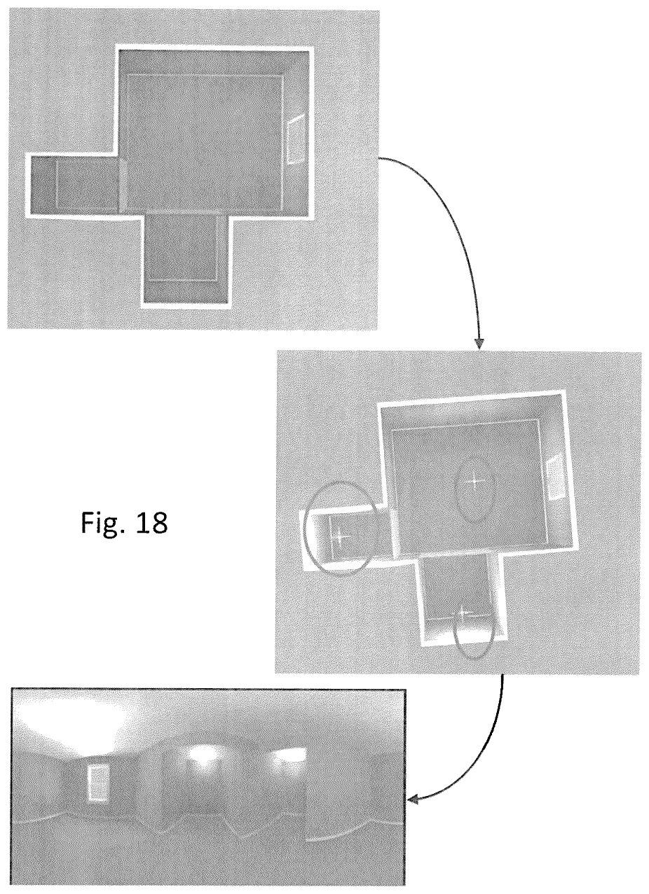

FIG. 17 illustrates a flowchart for calibrating studio lighting based at least in part on the one or more images and one or more perceptual parameters according to an exemplary embodiment. This process can take as input images/frames, framewise perceptual cues, camera parameters, and/or 3D surfaces/room shells and can output light sources (type, intensity, position, 3D model) and/or environment maps, such as a high dynamic range image (HDRI) map.

At step 1701 the system approximates windows in the room with area lights matching their geometries. This has the effect of simulating incoming natural lighting.

At step 1702 the system places point lights in areas where natural lighting cannot reach (e.g. through doors, corners). The point lights are distributed evenly across the remaining area to leave no corner without light coverage. This ensures equal distribution of lighting throughout the scene.

At step 1703 the system renders an environment map (HDRI) using a graphics engine. The graphics engine can be any suitable engine.

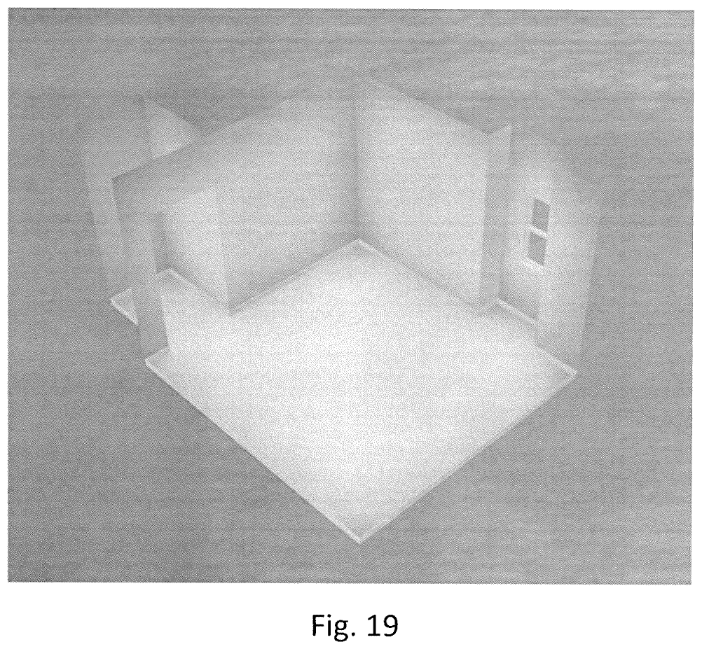

FIG. 18 illustrates an example of calibrating studio lighting according to an exemplary embodiment. As shown in FIG. 18, the process takes as input the room shell and produces multiple output light sources.

Returning to FIG. 15, at step 1503 ambient occlusion and indirect lighting are cached into one or more planes of the one or more rooms based at least in part on the one or more perceptual parameters. This step caches ambient occlusion and indirect lighting through baked lightmaps and skyboxes for enhanced room realism.

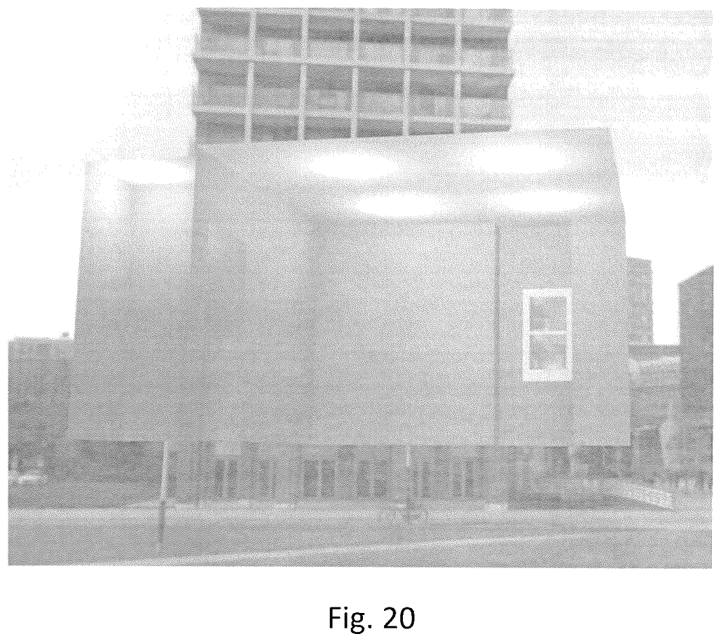

FIG. 19 illustrates an example of ambient occlusion according to an exemplary embodiment. Walls, ceilings, and floors can have ambient occlusion maps baked per scene. Room features, mainly doors and windows, can have ambient occlusion baked prior for efficiency.

Returning to FIG. 15, at step 1504 an external environment to the one or more rooms is generated based at least in part on the one or more images and the one or more perceptual parameters. This step uses the extracted room information, to classify and map the outside environment associated with the room, commonly called “skybox.”

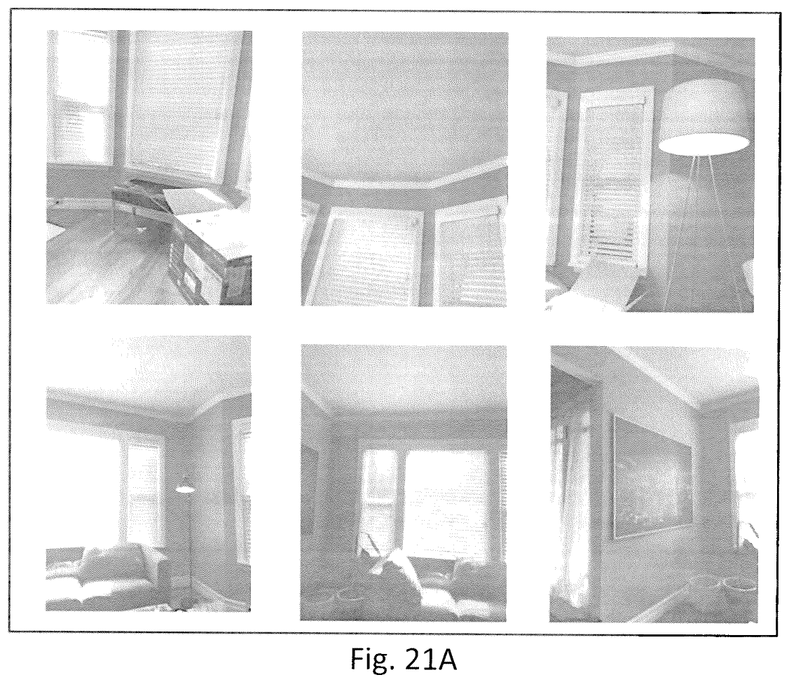

FIG. 20 illustrates an example of generating an external environment according to an exemplary embodiment. An exterior skybox can b generated and used in the scene, to contribute outside lighting and window visuals.

Returning to FIG. 1B, at step 105 a three-dimensional model of the one or more rooms is rendered based at least in part on the parametric model, the one or more assigned materials, and the lighting setup.

FIGS. 21A-21B illustrate a simplified example of image-based reconstruction according to an exemplary embodiment. In this example, imagery of a room is used to reconstruct a parametric CAD digital twin, which is further embellished with suggestive representations of flooring, wall paint, shadowing, architectural moulding, and discrete windows.

FIG. 21A illustrates the images of the room and FIG. 21B illustrates the digital twin. As shown in FIGS. 21A-21B, a room scan including a plurality of images of a room with different views is used to reconstruct a digital twin of the room with textures, lighting, and architecture that reflects the original room. The methods described herein can also be used to reconstruct multiple rooms or other interior or exterior spaces.

The present system is able to produce a fully enclosed layout even for partially scanned rooms. In the event that the views of the room(s) captured do not include all surfaces of the room, the user can be given an option to autocomplete or to render the room as-is. If the user elects to autocomplete, the missing sections of the surfaces can be estimates based on perceptual parameters, such as planes and edges and semantic information. Otherwise, if the user elects to the render the room as-is, the three-dimensional model can include gaps corresponding to the missing areas.

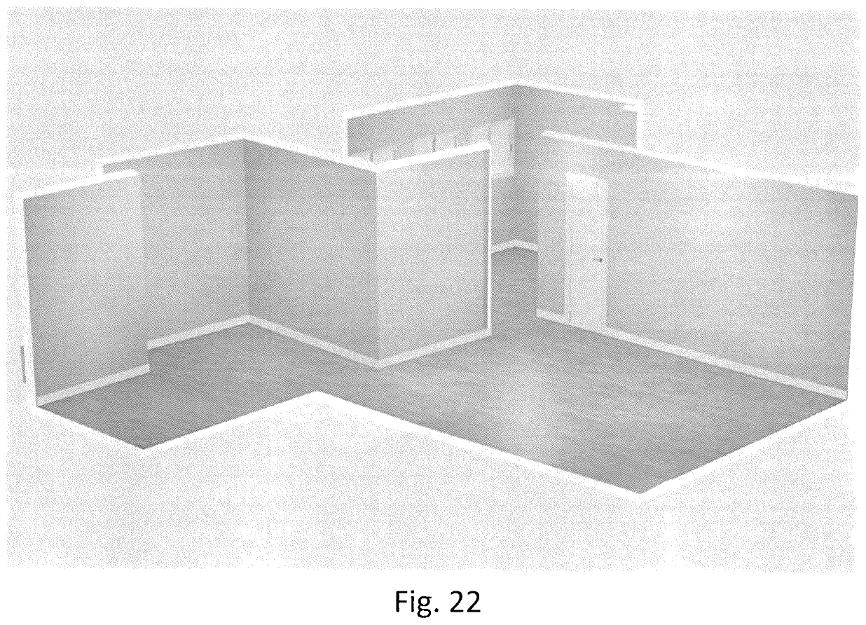

FIG. 22 illustrates an example of a multi-room space reconstructed according to the present method according to an exemplary embodiment.

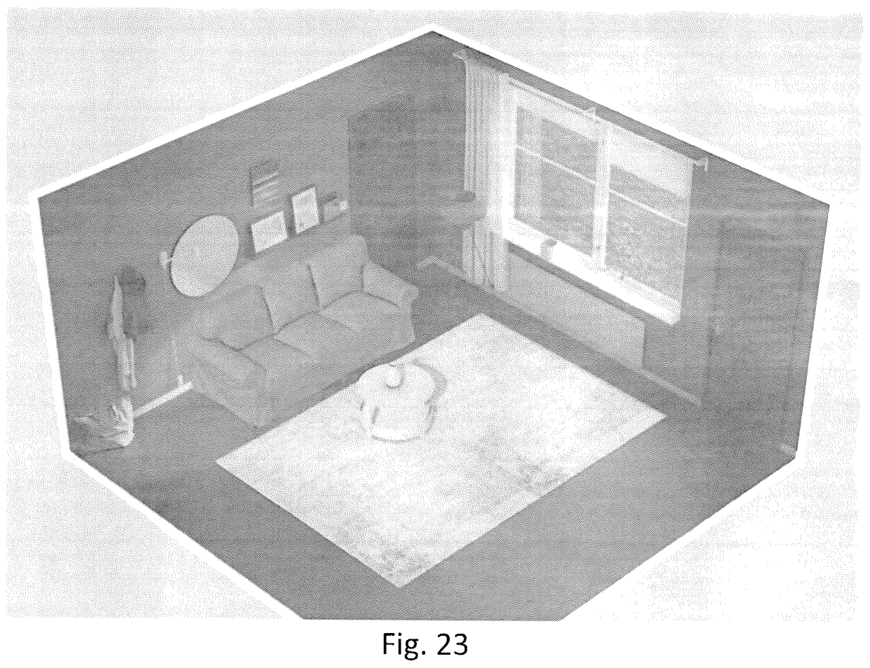

The three-dimensional model produced by the room reconstruction methods described herein can be utilized for virtual decoration. FIG. 23 illustrates a reconstructed and virtually decorated room according to an exemplary embodiment. Users can import furniture or wall hangings into the three-dimensional model, with real-time lighting effects and changes to the architectural elements being shown as objects are moved around (e.g., changing lights and shadows). Users can also delete existing items or replace existing items with proxy furniture, as described above.

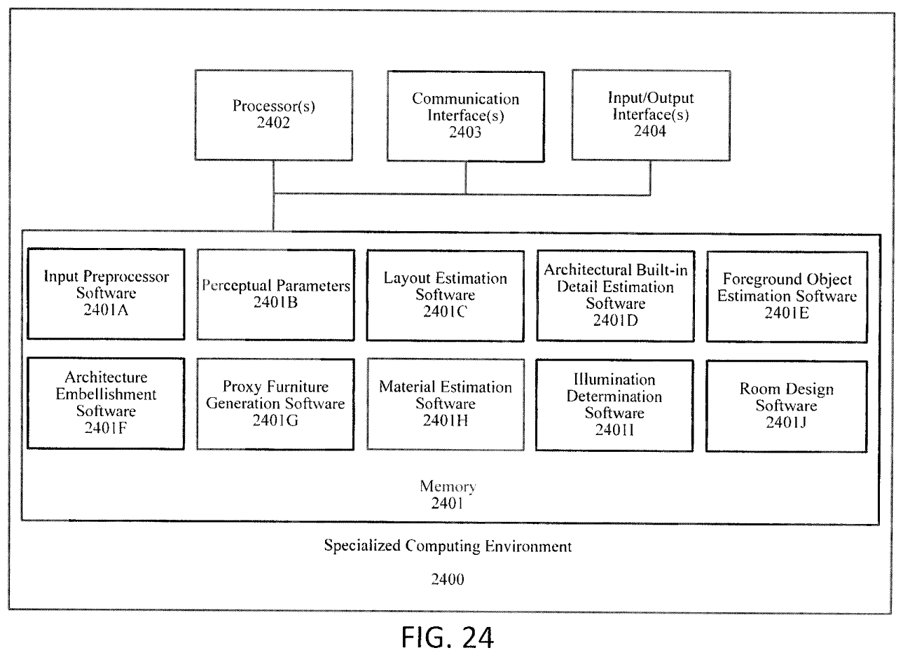

FIG. 24 illustrates the components of a specialized computing environment 2400 configured to perform the processes described herein according to an exemplary embodiment. Specialized computing environment 2400 is a computing device that includes a memory 2401 that is a non-transitory computer-readable medium and can be volatile memory (e.g., registers, cache, RAM), non-volatile memory (e.g., ROM, EEPROM, flash memory, etc.), or some combination of the two.

As shown in FIG. 24, memory 2401 can include input preprocessor software 2401A, perceptual parameters 2401B, layout estimation software 2401C, architectural built-in detail estimation software 2401D, foreground object estimation software 2401E, architecture embellishment software 2401F, proxy furniture generation software 2401G, material estimation software 2401H, illumination determination software 24001, and/or room design software 2401J.

Each of the program and software components in memory 2401 store specialized instructions and data structures configured to perform the corresponding functionality and techniques described herein.

All of the software stored within memory 2401 can be stored as a computer-readable instructions, that when executed by one or more processors 2402, cause the processors to perform the functionality described with respect to FIGS. 1-23.

Processor(s) 2402 execute computer-executable instructions and can be a real or virtual processors. In a multi-processing system, multiple processors or multicore processors can be used to execute computer-executable instructions to increase processing power and/or to execute certain software in parallel.

Specialized computing environment 2400 additionally includes a communication interface 2403, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 2400 further includes input and output interfaces 2404 that allow users (such as system administrators) to provide input to the system to display information, to edit data stored in memory 2401, or to perform other administrative functions.

An interconnection mechanism (shown as a solid line in FIG. 24), such as a bus, controller, or network interconnects the components of the specialized computing environment 6400.

Input and output interfaces 2404 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 2400.

Specialized computing environment 2400 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 2400.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

1. A method executed by one or more computing devices for room reconstruction, the method comprising:
storing, by at least one of the one or more computing devices, a parametric model of one or more rooms, the parametric model being generated based at least in part on extraction of one or more perceptual parameters from one or more images corresponding to one or more views of the one or more rooms and estimation of an architectural layout of the one or more rooms based at least in part on the one or more perceptual parameters;
augmenting, by at least one of the one or more computing devices, the parametric model by identifying one or more architectural elements in the architectural layout and replacing the one or more architectural elements in the parametric model with one or more architectural models corresponding to the one or more architectural elements;
assigning, by at least one of the one or more computing devices, one or more materials to one or more surfaces of the parametric model based at least in part on at least one of the one or more perceptual parameters; and
determining, by at least one of the one or more computing devices, a lighting setup based at least in part on at least one of the one or more perceptual parameters; and
rendering, by at least one of the one or more computing devices, a three-dimensional model of the one or more rooms based at least in part on the parametric model, the one or more assigned materials, and the lighting setup.

2. The method of claim 1, further comprising generating, by at least one of the one or more computing devices, the parametric model of the one or more rooms by:
receiving a plurality of images corresponding to a plurality of views of the one or more rooms;
extracting the one or more perceptual parameters from one or more images in the plurality of images, the one or more perceptual parameters comprising semantic information;
estimating an architectural layout of the one or more rooms based at least in part on the one or more perceptual parameters;
identifying one or more built-in architectural elements within the architectural layout based at least in part on the semantic information; and
identifying one or more movable objects in the one or more rooms based at least in part on the one or more perceptual parameters.

3. The method of claim 2, wherein receiving a plurality of images corresponding to a plurality of views of the one or more rooms comprises:
transmitting one or more instructions to a user device for capturing a plurality of images of the one or more rooms; and
receiving the plurality of images from the user device.

4. The method of claim 2, wherein extracting the one or more perceptual parameters from one or more images in the plurality of images comprises:
identifying one or more images in the plurality of images based at least in part on one or more of: image quality or data integrity; and
estimating the one or more perceptual parameters based at least in part on one or more images.

5. The method of claim 2, wherein estimating an architectural layout of the one or more rooms based at least in part on the one or more perceptual parameters comprises:
generating a three-dimensional semantic reconstruction of the one or more rooms based at least in part on the one or more images and the one or more perceptual parameters; and
estimating the architectural layout based at least in part on the three-dimensional semantic reconstruction and the one or more perceptual parameters.

6. The method of claim 5, wherein identifying one or more built-in architectural elements within the architectural layout based at least in part on the semantic information comprises:
identifying one or more locations of the one or more built-in architectural elements within the one or more rooms based at least in part on the three-dimensional semantic reconstruction of the one or more rooms; and
generating one or more bounding volumes corresponding to the one or more built-in architectural elements, each bounding volume being associated with a location and class of a corresponding built-in architectural element.

7. The method of claim 2, wherein identifying one or more movable objects in the one or more rooms based at least in part on the one or more perceptual parameters further comprises:
identifying one or more movable objects in the one or more rooms based at least in part on the one or more images and the one or more perceptual parameters; and
identifying, for each one movable object in the one or more movable objects, an object type, a semantic bounding box, and a three-dimensional orientation.

8. The method of claim 1, further comprising refining, by at least one of the one or more computing device, the parametric model by one or more of:
inserting one or more core architectural elements into the architectural layout based at least in part on the one or more perceptual parameters;
extruding one or more wall planes in the architectural layout based at least in part on the one or more perceptual parameters or one or more construction parameters; or
updating a ceiling geometry in the architectural layout based at least in part on one or more surface connectivity relationships of one or more planes in the architectural layout.

9. The method of claim 1, wherein augmenting the parametric model by identifying one or more architectural elements in the architectural layout and replacing the one or more architectural elements in the parametric model with one or more architectural models corresponding to the one or more architectural elements comprises:
identifying at least one built-in architectural element corresponding to at least one location in the architectural layout;
identifying at least one image corresponding to the at least one location, the at least one image comprising a view of the at least one architectural element;
identifying at least one architectural model corresponding to the at least one architectural element based at least in part on the view of the at least one architectural element; and
replacing the at least one built-in architectural element at the at least one location in the parametric model with the at least one architectural model.

10. The method of claim 1, wherein augmenting the parametric model by identifying one or more architectural elements in the architectural layout and replacing the one or more architectural elements in the parametric model with one or more architectural models corresponding to the one or more architectural elements comprises:
identifying one or more trim elements in the architectural layout based at least in part on the one or more perceptual parameters;
replacing the one or more trim elements in the parametric model with one or more refined trim models based at least in part on part on the architectural layout and the one or more perceptual parameters.

11. The method of claim 1, further comprising replacing movable objects in the parametric model with proxy objects by:
identifying, by at least one of the one or more computing devices, at least one movable object in one or more movable objects, the at least one movable object having one or more corresponding images, a corresponding object type, and a corresponding semantic bounding box;
identifying, by at least one of the one or more computing devices, at least one proxy object corresponding to the at least one movable object based at least in part on the one or more images, the object type, and the semantic bounding box; and
inserting, by at least one of the one or more computing devices, the at least one proxy object into the parametric model of the one or more rooms.

12. The method of claim 1, wherein assigning one or more materials to one or more surfaces of the parametric model based at least in part on at least one of the one or more perceptual parameters comprises:
estimating a plurality of material classes corresponding to a plurality of surfaces of the parametric model based at least in part on the one or more images and the one or more perceptual parameters;
assigning one or more physically-based rendering materials to the one or more surfaces based at least in part on the one or more images and one or more material classes in the plurality of material classes.

13. The method of claim 12, wherein assigning one or more physically-based rendering materials to the one or more surfaces based at least in part on the one or more images and one or more material classes in the plurality of material classes comprises, for each surface in the one or more surfaces:
identifying a plurality of pixels of the surface;
estimating core material properties of the surface based at least in part on the plurality of pixels;
determining a physically-based rendering material based at least in part on the core material properties and at least one material type in the one or more material classes;
aligning a color of the physically-based rendering material with the estimated core material properties; and
normalizing the aligned color based on one or more objects having a known color on the surface.

14. The method of claim 1, wherein determining a lighting setup based at least in part on at least one of the one or more perceptual parameters comprises one or more of:
modeling one or more room light sources based at least in part on the one or more images and the one or more perceptual parameters;
calibrating studio lighting based at least in part on the one or more images and one or more perceptual parameters;
caching ambient occlusion and indirect lighting into one or more planes of the one or more rooms based at least in part on the one or more perceptual parameters; or
generating an external environment to the one or more rooms based at least in part on the one or more images and the one or more perceptual parameters.

15. A apparatus executed by one or more computing devices for room reconstruction, the apparatus comprising:
one or more processors; and
one or more memories operatively coupled to at least one of the one or more processors and having instructions stored thereon that, when executed by at least one of the one or more processors, cause at least one of the one or more processors to:
store a parametric model of one or more rooms, the parametric model being generated based at least in part on extraction of one or more perceptual parameters from one or more images corresponding to one or more views of the one or more rooms and estimation of an architectural layout of the one or more rooms based at least in part on the one or more perceptual parameters;
augment the parametric model by identifying one or more architectural elements in the architectural layout and replacing the one or more architectural elements in the parametric model with one or more architectural models corresponding to the one or more architectural elements;
assign one or more materials to one or more surfaces of the parametric model based at least in part on at least one of the one or more perceptual parameters; and
determine a lighting setup based at least in part on at least one of the one or more perceptual parameters; and
render a three-dimensional model of the one or more rooms based at least in part on the parametric model, the one or more assigned materials, and the lighting setup.

16. The apparatus of claim 15, wherein at least one of the one or more memories has further instructions stored thereon that, when executed by at least one of the one or more processors, cause at least one of the one or more processors to generate the parametric model of the one or more rooms by:
receiving a plurality of images corresponding to a plurality of views of the one or more rooms;
extracting the one or more perceptual parameters from one or more images in the plurality of images, the one or more perceptual parameters comprising semantic information;
estimating an architectural layout of the one or more rooms based at least in part on the one or more perceptual parameters;
identifying one or more built-in architectural elements within the architectural layout based at least in part on the semantic information; and
identifying one or more movable objects in the one or more rooms based at least in part on the one or more perceptual parameters.

17. The apparatus of claim 16, wherein the instructions that, when executed by at least one of the one or more processors, cause at least one of the one or more processors to receive a plurality of images corresponding to a plurality of views of the one or more rooms further cause at least one of the one or more processors to:
transmit one or more instructions to a user device for capturing a plurality of images of the one or more rooms; and
receive the plurality of images from the user device.

18. The apparatus of claim 16, wherein the instructions that, when executed by at least one of the one or more processors, cause at least one of the one or more processors to extract the one or more perceptual parameters from one or more images in the plurality of images further cause at least one of the one or more processors to:
identify one or more images in the plurality of images based at least in part on one or more of: image quality or data integrity; and
estimate the one or more perceptual parameters based at least in part on one or more images.

19. The apparatus of claim 16, wherein the instructions that, when executed by at least one of the one or more processors, cause at least one of the one or more processors to estimate an architectural layout of the one or more rooms based at least in part on the one or more perceptual parameters further cause at least one of the one or more processors to:
generate a three-dimensional semantic reconstruction of the one or more rooms based at least in part on the one or more images and the one or more perceptual parameters; and
estimate the architectural layout based at least in part on the three-dimensional semantic reconstruction and the one or more perceptual parameters.

20. The apparatus of claim 19, wherein the instructions that, when executed by at least one of the one or more processors, cause at least one of the one or more processors to identify one or more built-in architectural elements within the architectural layout based at least in part on the semantic information further cause at least one of the one or more processors to:
identify one or more locations of the one or more built-in architectural elements within the one or more rooms based at least in part on the three-dimensional semantic reconstruction of the one or more rooms; and
generate one or more bounding volumes corresponding to the one or more built-in architectural elements, each bounding volume being associated with a location and class of a corresponding built-in architectural element.

21. The apparatus of claim 16, wherein the instructions that, when executed by at least one of the one or more processors, cause at least one of the one or more processors to identify one or more movable objects in the one or more rooms based at least in part on the one or more perceptual parameters further cause at least one of the one or more processors to:
identify one or more movable objects in the one or more rooms based at least in part on the one or more images and the one or more perceptual parameters; and
identify, for each one movable object in the one or more movable objects, an object type, a semantic bounding box, and a three-dimensional orientation.

22. The apparatus of claim 15, wherein at least one of the one or more memories has further instructions stored thereon that, when executed by at least one of the one or more processors, cause at least one of the one or more processors to refine the parametric model by one or more of:
inserting one or more core architectural elements into the architectural layout based at least in part on the one or more perceptual parameters;
extruding one or more wall planes in the architectural layout based at least in part on the one or more perceptual parameters or one or more construction parameters; or
updating a ceiling geometry in the architectural layout based at least in part on one or more surface connectivity relationships of one or more planes in the architectural layout.

23. The apparatus of claim 15, wherein the instructions that, when executed by at least one of the one or more processors, cause at least one of the one or more processors to augment the parametric model by identifying one or more architectural elements in the architectural layout and replacing the one or more architectural elements in the parametric model with one or more architectural models corresponding to the one or more architectural elements further cause at least one of the one or more processors to:
identify at least one built-in architectural element corresponding to at least one location in the architectural layout;
identify at least one image corresponding to the at least one location, the at least one image comprising a view of the at least one architectural element;
identify at least one architectural model corresponding to the at least one architectural element based at least in part on the view of the at least one architectural element; and
replace the at least one built-in architectural element at the at least one location in the parametric model with the at least one architectural model.

24. The apparatus of claim 15, wherein the instructions that, when executed by at least one of the one or more processors, cause at least one of the one or more processors to augment the parametric model by identifying one or more architectural elements in the architectural layout and replacing the one or more architectural elements in the parametric model with one or more architectural models corresponding to the one or more architectural elements further cause at least one of the one or more processors to:
identify one or more trim elements in the architectural layout based at least in part on the one or more perceptual parameters;
replace the one or more trim elements in the parametric model with one or more refined trim models based at least in part on part on the architectural layout and the one or more perceptual parameters.

25. The apparatus of claim 15, wherein at least one of the one or more memories has further instructions stored thereon that, when executed by at least one of the one or more processors, cause at least one of the one or more processors to replace movable objects in the parametric model with proxy objects by:
identifying at least one movable object in one or more movable objects, the at least one movable object having one or more corresponding images, a corresponding object type, and a corresponding semantic bounding box;
identifying at least one proxy object corresponding to the at least one movable object based at least in part on the one or more images, the object type, and the semantic bounding box; and
inserting the at least one proxy object into the parametric model of the one or more rooms.

26. The apparatus of claim 15, wherein the instructions that, when executed by at least one of the one or more processors, cause at least one of the one or more processors to assign one or more materials to one or more surfaces of the parametric model based at least in part on at least one of the one or more perceptual parameters further cause at least one of the one or more processors to:
estimate a plurality of material classes corresponding to a plurality of surfaces of the parametric model based at least in part on the one or more images and the one or more perceptual parameters;
assign one or more physically-based rendering materials to the one or more surfaces based at least in part on the one or more images and one or more material classes in the plurality of material classes.

27. The apparatus of claim 26, wherein the instructions that, when executed by at least one of the one or more processors, cause at least one of the one or more processors to assign one or more physically-based rendering materials to the one or more surfaces based at least in part on the one or more images and one or more material classes in the plurality of material classes further cause at least one of the one or more processors to, for each surface in the one or more surfaces:
identify a plurality of pixels of the surface;
estimate core material properties of the surface based at least in part on the plurality of pixels;
determine a physically-based rendering material based at least in part on the core material properties and at least one material type in the one or more material classes;
align a color of the physically-based rendering material with the estimated core material properties; and
normalize the aligned color based on one or more objects having a known color on the surface.

28. The apparatus of claim 15, wherein the instructions that, when executed by at least one of the one or more processors, cause at least one of the one or more processors to determine a lighting setup based at least in part on at least one of the one or more perceptual parameters further cause at least one of the one or more processors to perform one or more of:
modeling one or more room light sources based at least in part on the one or more images and the one or more perceptual parameters;
calibrating studio lighting based at least in part on the one or more images and one or more perceptual parameters;
caching ambient occlusion and indirect lighting into one or more planes of the one or more rooms based at least in part on the one or more perceptual parameters; or
generating an external environment to the one or more rooms based at least in part on the one or more images and the one or more perceptual parameters.

29. At least one non-transitory computer-readable medium storing computer-readable instructions for room reconstruction that, when executed by one or more computing devices, cause at least one of the one or more computing devices to:
store a parametric model of one or more rooms, the parametric model being generated based at least in part on extraction of one or more perceptual parameters from one or more images corresponding to one or more views of the one or more rooms and estimation of an architectural layout of the one or more rooms based at least in part on the one or more perceptual parameters;
augment the parametric model by identifying one or more architectural elements in the architectural layout and replacing the one or more architectural elements in the parametric model with one or more architectural models corresponding to the one or more architectural elements;
assign one or more materials to one or more surfaces of the parametric model based at least in part on at least one of the one or more perceptual parameters; and
determine a lighting setup based at least in part on at least one of the one or more perceptual parameters; and
render a three-dimensional model of the one or more rooms based at least in part on the parametric model, the one or more assigned materials, and the lighting setup.

30. The at least one non-transitory computer-readable medium of claim 29, further storing computer-readable instructions that, when executed by at least one of the one or more computing devices, cause at least one of the one or more computing devices to generate the parametric model of the one or more rooms by:
receiving a plurality of images corresponding to a plurality of views of the one or more rooms;
extracting the one or more perceptual parameters from one or more images in the plurality of images, the one or more perceptual parameters comprising semantic information;
estimating an architectural layout of the one or more rooms based at least in part on the one or more perceptual parameters;
identifying one or more built-in architectural elements within the architectural layout based at least in part on the semantic information; and
identifying one or more movable objects in the one or more rooms based at least in part on the one or more perceptual parameters.

31. The at least one non-transitory computer-readable medium of claim 30, wherein the instructions that, when executed by at least one of the one or more computing devices, cause at least one of the one or more computing devices to receive a plurality of images corresponding to a plurality of views of the one or more rooms further cause at least one of the one or more computing devices to:
transmit one or more instructions to a user device for capturing a plurality of images of the one or more rooms; and
receive the plurality of images from the user device.

32. The at least one non-transitory computer-readable medium of claim 30, wherein the instructions that, when executed by at least one of the one or more computing devices, cause at least one of the one or more computing devices to extract the one or more perceptual parameters from one or more images in the plurality of images further cause at least one of the one or more computing devices to:
identify one or more images in the plurality of images based at least in part on one or more of: image quality or data integrity; and
estimate the one or more perceptual parameters based at least in part on one or more images.

33. The at least one non-transitory computer-readable medium of claim 30, wherein the instructions that, when executed by at least one of the one or more computing devices, cause at least one of the one or more computing devices to estimate an architectural layout of the one or more rooms based at least in part on the one or more perceptual parameters further cause at least one of the one or more computing devices to:
generate a three-dimensional semantic reconstruction of the one or more rooms based at least in part on the one or more images and the one or more perceptual parameters; and
estimate the architectural layout based at least in part on the three-dimensional semantic reconstruction and the one or more perceptual parameters.

34. The at least one non-transitory computer-readable medium of claim 33, wherein the instructions that, when executed by at least one of the one or more computing devices, cause at least one of the one or more computing devices to identify one or more built-in architectural elements within the architectural layout based at least in part on the semantic information further cause at least one of the one or more computing devices to:
identify one or more locations of the one or more built-in architectural elements within the one or more rooms based at least in part on the three-dimensional semantic reconstruction of the one or more rooms; and
generate one or more bounding volumes corresponding to the one or more built-in architectural elements, each bounding volume being associated with a location and class of a corresponding built-in architectural element.

35. The at least one non-transitory computer-readable medium of claim 30, wherein the instructions that, when executed by at least one of the one or more computing devices, cause at least one of the one or more computing devices to identify one or more movable objects in the one or more rooms based at least in part on the one or more perceptual parameters further cause at least one of the one or more computing devices to:
identify one or more movable objects in the one or more rooms based at least in part on the one or more images and the one or more perceptual parameters; and
identify, for each one movable object in the one or more movable objects, an object type, a semantic bounding box, and a three-dimensional orientation.

36. The at least one non-transitory computer-readable medium of claim 29, further storing computer-readable instructions that, when executed by at least one of the one or more computing devices, cause at least one of the one or more computing devices to refine the parametric model by one or more of:
inserting one or more core architectural elements into the architectural layout based at least in part on the one or more perceptual parameters;
extruding one or more wall planes in the architectural layout based at least in part on the one or more perceptual parameters or one or more construction parameters; or
updating a ceiling geometry in the architectural layout based at least in part on one or more surface connectivity relationships of one or more planes in the architectural layout.

37. The at least one non-transitory computer-readable medium of claim 29, wherein the instructions that, when executed by at least one of the one or more computing devices, cause at least one of the one or more computing devices to augment the parametric model by identifying one or more architectural elements in the architectural layout and replacing the one or more architectural elements in the parametric model with one or more architectural models corresponding to the one or more architectural elements further cause at least one of the one or more computing devices to:
identify at least one built-in architectural element corresponding to at least one location in the architectural layout;
identify at least one image corresponding to the at least one location, the at least one image comprising a view of the at least one architectural element;
identify at least one architectural model corresponding to the at least one architectural element based at least in part on the view of the at least one architectural element; and
replace the at least one built-in architectural element at the at least one location in the parametric model with the at least one architectural model.

38. The at least one non-transitory computer-readable medium of claim 29, wherein the instructions that, when executed by at least one of the one or more computing devices, cause at least one of the one or more computing devices to augment the parametric model by identifying one or more architectural elements in the architectural layout and replacing the one or more architectural elements in the parametric model with one or more architectural models corresponding to the one or more architectural elements further cause at least one of the one or more computing devices to:
identify one or more trim elements in the architectural layout based at least in part on the one or more perceptual parameters;
replace the one or more trim elements in the parametric model with one or more refined trim models based at least in part on part on the architectural layout and the one or more perceptual parameters.

39. The at least one non-transitory computer-readable medium of claim 29, further storing computer-readable instructions that, when executed by at least one of the one or more computing devices, cause at least one of the one or more computing devices to replace movable objects in the parametric model with proxy objects by:
identifying at least one movable object in one or more movable objects, the at least one movable object having one or more corresponding images, a corresponding object type, and a corresponding semantic bounding box;
identifying at least one proxy object corresponding to the at least one movable object based at least in part on the one or more images, the object type, and the semantic bounding box; and
inserting the at least one proxy object into the parametric model of the one or more rooms.

40. The at least one non-transitory computer-readable medium of claim 29, wherein the instructions that, when executed by at least one of the one or more computing devices, cause at least one of the one or more computing devices to assign one or more materials to one or more surfaces of the parametric model based at least in part on at least one of the one or more perceptual parameters further cause at least one of the one or more computing devices to:
estimate a plurality of material classes corresponding to a plurality of surfaces of the parametric model based at least in part on the one or more images and the one or more perceptual parameters;
assign one or more physically-based rendering materials to the one or more surfaces based at least in part on the one or more images and one or more material classes in the plurality of material classes.

41. The at least one non-transitory computer-readable medium of claim 40, wherein the instructions that, when executed by at least one of the one or more computing devices, cause at least one of the one or more computing devices to assign one or more physically-based rendering materials to the one or more surfaces based at least in part on the one or more images and one or more material classes in the plurality of material classes further cause at least one of the one or more computing devices to, for each surface in the one or more surfaces:
identify a plurality of pixels of the surface;
estimate core material properties of the surface based at least in part on the plurality of pixels;
determine a physically-based rendering material based at least in part on the core material properties and at least one material type in the one or more material classes;
align a color of the physically-based rendering material with the estimated core material properties; and
normalize the aligned color based on one or more objects having a known color on the surface.

42. The at least one non-transitory computer-readable medium of claim 29, wherein the instructions that, when executed by at least one of the one or more computing devices, cause at least one of the one or more computing devices to determine a lighting setup based at least in part on at least one of the one or more perceptual parameters further cause at least one of the one or more computing devices to perform one or more of:
modeling one or more room light sources based at least in part on the one or more images and the one or more perceptual parameters;
calibrating studio lighting based at least in part on the one or more images and one or more perceptual parameters;
caching ambient occlusion and indirect lighting into one or more planes of the one or more rooms based at least in part on the one or more perceptual parameters; or
generating an external environment to the one or more rooms based at least in part on the one or more images and the one or more perceptual parameters.
